(19) United States
(12) Patent Application Publication
(10) Pub. No.: US 2024/0326026 A1
(43) Pub. Date: Oct. 3, 2024

(54) METAL CATALYST WITH VERTICAL HETEROJUNCTION INTERFACE AND METHOD OF PRODUCING THE SAME

(71) Applicant: Research & Business Foundation SUNGKYUNKWAN UNIVERSITY, Suwon-si (KR)

(72) Inventors: Tae Sung KIM, Seoul (KR); Jin Ill CHO, Busan (KR); Hyun Ho SEOK, Suwon-si (KR); Pil Jin YOO, Suwon-si (KR); Min Jun KIM, Jinju-si (KR)

(73) Assignee: Research & Business Foundation SUNGKYUNKWAN UNIVERSITY, Suwon-si (KR)

(21) Appl. No.: 18/618,539

(22) Filed: Mar. 27, 2024

(30) Foreign Application Priority Data
Mar. 30, 2023 (KR) 10-2023-0042191

(51) Int. Cl. B01J 27/04; B01J 35/00; B01J 35/45; B01J 35/80; B01J 37/34

(52) U.S. Cl. CPC B01J 27/04; B01J 35/19; B01J 35/45; B01J 35/80; B01J 37/349; B01J 2235/15; B01J 2235/30

(57) ABSTRACT

Disclosed are a metal catalyst with a vertical heterojunction interface and a method of producing the same. The metal catalyst with the vertical heterojunction interface according to an embodiment of the disclosure allows hydrogen adsorbed on a transition metal oxide to be transferred to a transition metal sulfide (hydrogen spillover phenomenon), thereby having effects on having both excellent hydrogen adsorption performance and excellent catalyst activities.

### CROSS REFERENCE TO RELATED APPLICATION

The present application claims priority to Korean Patent Application No. 10-2023-0042191, filed Mar. 30, 2023, the entire contents of which is incorporated herein for all purposes by this reference.

### BACKGROUND OF THE INVENTION

### Field of the Invention

The disclosure relates to a metal catalyst with a vertical heterojunction interface and a method of producing the same.

### Description of the Related Art

With rapid increase in worldwide energy consumption, concerns about the exhaustion of fossil fuels and environmental pollution due to carbon dioxide emissions have led to the need for new and renewable energy. Therefore, to replace the existing fossil fuels with the new and renewable energy, energy conversion devices such as fuel cells and water electrolysis electrocatalysts are in the limelight.

In particular, electrocatalysts based on precious metal such as Pt, Pd, Ru, Rh, and Ir have superior electrochemical activities, and thus have proven their excellence as the devices for converting new and renewable energy to meet energy demands. However, the materials based on the precious metal are insufficient to replace the fossil fuels and meet the explosively increasing energy demands due to their high cost and scarcity.

Accordingly, there have been researched various materials to replace the electrocatalysts based on the precious metal. In particular, electrocatalysts based on transition metal are actively being studied. Among the electrocatalysts based on the transition metal, electrocatalysts based on transition metal sulfide, such as WS₂ and MoS₂, have superior electrochemical activities but are not expensive, thereby having the potential as materials that can replace the electrocatalysts based on the precious metal and overcome limitations to industrialization. However, the transition metal sulfides have limitations of poor hydrogen adsorption properties despite of having excellent catalytic activities. To improve the hydrogen adsorption properties of the electrocatalysts based on the transition metal, methods of introducing heterogeneous compounds or heterojunction interfaces having specific physical properties, e.g., providing a hydrogen spillover phenomenon are emerging. However, Conventional heterojunction interfaces are formed having completely separated core-shell shapes, and their properties attributed to the improvement of catalytic activities are limited to the interfaces and thus locally exhibited.

Specifically, a conventional method of introducing oxide heterojunction interfaces involving high-temperature heat treatment has problems that an oxide film formed only on a surface as oxidation starts from the surface may cause the occurrence of the hydrogen spillover phenomenon for improving the electrochemical activities to be limited to only the surface, and the oxide film not bonded to the transition metal sulfide degrades the electrical properties of the material and decreases the electrochemical activities.

Therefore, it is required to research and develop a material that is economical with no precious metal and exhibits high electrocatalyst performance.

### DOCUMENTS OF RELATED ART

(Patent Document 1) Korean Patent Publication No. 10-2022-0111344

### SUMMARY OF THE INVENTION

An aspect of the disclosure is to provide a metal catalyst with a vertical heterojunction interface, which allows hydrogen adsorbed onto transition metal oxide to be transferred to transition metal sulfide, and a method of producing the same.

Technical problems to be solved in the disclosure are not limited to the forementioned technical problems, and other unmentioned technical problems can be clearly understood from the following description by a person having ordinary knowledge in the art to which the disclosure pertains.

To solve the technical problems, an embodiment of the disclosure provides a metal catalyst.

According to an embodiment of the disclosure, the metal catalyst may include: a nano-crystallized transition metal sulfide matrix having a layered structure; and an amorphous transition metal oxide located in a space between crystals of the transition metal sulfide matrix, and heterogeneously bonded to the transition metal sulfide matrix.

Further, according to an embodiment of the disclosure, the amorphous transition metal oxide and the transition metal sulfide matrix may be heterogeneously bonded so that the transition metal sulfide matrix and the amorphous transition metal oxide can include a vertical interface therebetween as the amorphous transition metal oxide is vertically formed in the space of the transition metal sulfide matrix.

Further, according to an embodiment of the disclosure, hydrogen adsorbed on the amorphous transition metal oxide may be transferred to the transition metal sulfide matrix.

Further, according to an embodiment of the disclosure, a mixing stoichiometric ratio of the transition metal sulfide matrix and the transition metal oxide may range from 1:0.6 to 1:1.7.

Further, according to an embodiment of the disclosure, the amorphous transition metal oxide may be heterogeneously bonded in the space between the crystals of the transition metal sulfide matrix by ion penetration.

Further, according to an embodiment of the disclosure, the interface where the transition metal sulfide matrix and the amorphous transition metal oxide are heterogeneously bonded may have a length of 10 nm to 20 nm.

Further, according to an embodiment of the disclosure, the transition metal sulfide matrix may include one or more selected from a group consisting of WS₂, MoS₂, VS₂, TiS₂, ReS₂, NiS₂, CoS₂ and TaS₂.

Further, according to an embodiment of the disclosure, the amorphous transition metal oxide may include one or more selected from a group consisting of WO₃, MOO₃, V₂O₅, TiO₂, ReO₂, NiO₂, CO₃O₄ and TiO₂.

To solve the technical problems, another embodiment of the disclosure provided a method of producing a metal catalyst.

According to an embodiment of the disclosure, a method of producing a metal catalyst may include: preparing a nano-crystallized transition metal sulfide matrix on a wafer; and
preparing a metal catalyst with the amorphous transition metal oxide heterogeneously bonded between crystals of the nano-crystallized transition metal sulfide matrix by treating the plasma at a preset temperature for a preset period of time under an atmosphere of oxygen gas and inert gas.

Further, according to an embodiment of the disclosure, the preparation of the nano-crystallized transition metal sulfide matrix on the wafer includes:
depositing a transition metal thin film having a nanometer thickness on the wafer;
preparing a wafer, on which a surface-treated transition metal thin film is deposited, by injecting the wafer formed with the transition metal thin film into a plasma chemical vapor deposition device and then removing a natural oxide film from the transition metal thin film formed on the wafer through hydrogen plasma treatment; and
preparing a nano-crystallized transition metal sulfide matrix by heating the wafer, on which the surface-treated transition metal thin film is deposited, to a preset temperature under an inert gas atmosphere and then adding inert gas and hydrogen sulfide gas and performing plasma treatment to cause a sulfidation reaction by ion penetration on the surface-treated transition metal thin film.

Further, according to an embodiment of the disclosure, the amorphous transition metal oxide and the transition metal sulfide matrix may be heterogeneously bonded having a vertical interface as the amorphous transition metal oxide is formed vertically penetrating the transition metal sulfide matrix.

Further, according to an embodiment of the disclosure, in the deposition of the transition metal thin film having the nanometer thickness on the wafer, the thickness of the transition metal thin film may range from 1 nm to 2 nm.

Further, according to an embodiment of the disclosure, in the preparation of the nano-crystallized transition metal sulfide matrix, the preset temperature may range from 100° C. to 150° C.

Further, according to an embodiment of the disclosure, in the preparation of the metal catalyst with the heterogeneously bonded amorphous transition metal oxide, the oxygen plasma treatment may be performed for 30 seconds to 90 seconds.

### BRIEF DESCRIPTION OF THE DRAWINGS

FIG. 1A is a schematic molecular diagram of a metal catalyst according to an embodiment of the disclosure.

FIG. 1B is a schematic molecular diagram of a metal catalyst according to an embodiment of the disclosure.

FIG. 1C is an atomic force microscope (AFM) image of a metal catalyst according to an embodiment of the disclosure.

FIG. 1D is a high-resolution transmission electron microcopy (HRTEM) image of a metal catalyst according to an embodiment of the disclosure.

FIG. 2A is a schematic diagram of how to produce a metal catalyst according to an embodiment of the disclosure.

FIG. 2B is a diagram showing an X-ray diffraction (XRD) analysis of a metal catalyst according to an embodiment of the disclosure.

FIG. 2C is a diagram showing an HRTEM surface analysis of a pristine 1T-WS₂ metal catalyst according to an embodiment of the disclosure.

FIG. 2D is a diagram showing an HRTEM surface analysis of a WSO-0.6 metal catalyst according to an embodiment of the disclosure.

FIG. 2E is a diagram showing an HRTEM surface analysis of a WSO-1.2 metal catalyst according to an embodiment of the disclosure.

FIG. 2F is a diagram showing an HRTEM surface analysis of a WSO-1.7 metal catalyst according to an embodiment of the disclosure.

FIG. 2G is a diagram showing an HRTEM cross-section analysis of a pristine 1T-WS₂ metal catalyst according to an embodiment of the disclosure.

FIG. 2H is a diagram showing an HRTEM cross-section analysis of a WSO-0.6 metal catalyst according to an embodiment of the disclosure.

FIG. 2I is a diagram showing an HRTEM cross-section analysis of a WSO-1.2 metal catalyst according to an embodiment of the disclosure.

FIG. 2J is a diagram showing an HRTEM cross-section analysis of a WSO-1.7 metal catalyst according to an embodiment of the disclosure.

FIG. 2K is a diagram showing an AFM analysis of a pristine 1T-WS₂ metal catalyst according to an embodiment of the disclosure depending on a penetration time of oxygen plasma.

FIG. 2L is a diagram showing an AFM analysis of a WSO-0.6 metal catalyst according to an embodiment of the disclosure depending on a penetration time of oxygen plasma.

FIG. 2M is a diagram showing an AFM analysis of a WSO-1.2 metal catalyst according to an embodiment of the disclosure depending on a penetration time of oxygen plasma.

FIG. 2N is a diagram showing an AFM analysis of a WSO-1.7 metal catalyst according to an embodiment of the disclosure depending on a penetration time of oxygen plasma.

FIG. 3A is a graph showing a chemical bond analysis result of a pristine 1T-WS₂ metal catalyst according to an embodiment of the disclosure depending on a penetration time of oxygen plasma.

FIG. 3B is a graph showing a chemical bond analysis result of a WSO-0.6 metal catalyst according to an embodiment of the disclosure depending on a penetration time of oxygen plasma.

FIG. 3C is a graph showing a chemical bond analysis result of a WSO-1.2 metal catalyst according to an embodiment of the disclosure depending on a penetration time of oxygen plasma.

FIG. 3D is a graph showing a chemical bond analysis result of a WSO-1.7 metal catalyst according to an embodiment of the disclosure depending on a penetration time of oxygen plasma.

FIG. 4A is a graph showing a hydrogen spillover material mechanism analysis based on cyclic voltammetry (CV) measurement of a pristine 1T-WS₂ metal catalyst according to an embodiment of the disclosure.

FIG. 4B is a graph showing a hydrogen spillover material mechanism analysis based on CV measurement of a WSO-0.6 metal catalyst according to an embodiment of the disclosure.

FIG. 4C is a graph showing a hydrogen spillover material mechanism analysis based on CV measurement of a WSO-1.2 metal catalyst according to an embodiment of the disclosure.

FIG. 4D is a graph showing a hydrogen spillover material mechanism analysis based on CV measurement of a WSO-1.7 metal catalyst according to an embodiment of the disclosure.

FIG. 5A is a graph showing an electrochemical property evaluation and a stability analysis based on hydrogen evolution reaction (HER) measurement of a pristine 1T-WS₂ metal catalyst according to an embodiment of the disclosure.

FIG. 5B is a graph showing an electrochemical property evaluation and a stability analysis based on HER measurement of a WSO-0.6 metal catalyst according to an embodiment of the disclosure.

FIG. 5C is a graph showing an electrochemical property evaluation and a stability analysis based on HER measurement of a WSO-1.2 metal catalyst according to an embodiment of the disclosure.

FIG. 5D is a graph showing an electrochemical property evaluation and a stability analysis based on HER measurement of a WSO-1.7 metal catalyst according to an embodiment of the disclosure.

FIG. 6A shows the Gibbs free energy of proton adsorption for each adsorption site on 1T-WS₂ and WO₃.

FIG. 6B is a density functional theory (DFT) analysis of a metal catalyst according to an embodiment of the disclosure.

FIG. 6C is a schematic diagram of an HER mechanism of a WSO catalyst according to an embodiment of the disclosure.

FIG. 7 shows a result of examining ion penetration distances and distribution uniformity after oxygen plasma treatment based on a cross-section energy dispersive spectroscopy (EDS) analysis of metal catalysts according to an embodiment of the disclosure.

FIG. 8A shows a result of a surface roughness change analysis after oxygen plasma penetration treatment of a pristine 1T-WS₂ metal catalyst according to an embodiment of the disclosure.

FIG. 8B shows a result of a surface roughness change analysis after oxygen plasma penetration treatment of a WSO-0.6 metal catalyst according to an embodiment of the disclosure.

FIG. 8C shows a result of a surface roughness change analysis after oxygen plasma penetration treatment of a WSO-1.2 metal catalyst according to an embodiment of the disclosure.

FIG. 8D shows a result of a surface roughness change analysis after oxygen plasma penetration treatment of a WSO-1.7 metal catalyst according to an embodiment of the disclosure.

FIG. 9A shows a result of a surface scanning electron microscope (SEM) analysis after oxygen plasma penetration treatment of a pristine 1T-WS₂ metal catalyst according to an embodiment of the disclosure.

FIG. 9B shows a result of a surface SEM analysis after oxygen plasma penetration treatment of a WSO-0.6 metal catalyst according to an embodiment of the disclosure.

FIG. 9C shows a result of a surface SEM analysis after oxygen plasma penetration treatment of a WSO-1.2 metal catalyst according to an embodiment of the disclosure.

FIG. 9D shows a result of a surface SEM analysis after oxygen plasma penetration treatment of a WSO-1.7 metal catalyst according to an embodiment of the disclosure.

FIG. 10A shows a result of an oxygen X-ray photoelectron spectroscopy (XPS) analysis after oxygen plasma penetration treatment of a pristine 1T-WS₂ metal catalyst according to an embodiment of the disclosure.

FIG. 10B shows a result of an oxygen XPS analysis after oxygen plasma penetration treatment of a WSO-0.6 metal catalyst according to an embodiment of the disclosure.

FIG. 10C shows a result of an oxygen XPS analysis after oxygen plasma penetration treatment of a WSO-1.2 metal catalyst according to an embodiment of the disclosure.

FIG. 10D shows a result of an oxygen XPS analysis after oxygen plasma penetration treatment of a WSO-1.7 metal catalyst according to an embodiment of the disclosure.

FIG. 11A shows a result of a sulfur XPS analysis after oxygen plasma penetration treatment of a metal catalyst (pristine 1T-WS₂) according to an embodiment of the disclosure.

FIG. 11B shows a result of a sulfur XPS analysis after oxygen plasma penetration treatment of a WSO-0.6 metal catalyst according to an embodiment of the disclosure.

FIG. 11C shows a result of a sulfur XPS analysis after oxygen plasma penetration treatment of a WSO-1.2 metal catalyst according to an embodiment of the disclosure.

FIG. 11D shows a result of a sulfur XPS analysis after oxygen plasma penetration treatment of a WSO-1.7 metal catalyst according to an embodiment of the disclosure.

FIG. 12A shows a result of dropping distilled water to check change in surface hydrophilicity/hydrophobicity depending on treatment time after oxygen plasma penetration treatment according to an embodiment of the disclosure.

FIG. 12B shows a result of dropping glycerol to check change in surface hydrophilicity/hydrophobicity depending on treatment time after oxygen plasma penetration treatment according to an embodiment of the disclosure.

FIG. 12C shows a result of dropping diiodomethane to check change in surface hydrophilicity/hydrophobicity depending on treatment time after oxygen plasma penetration treatment according to an embodiment of the disclosure.

FIG. 13A shows surface polarity and dispersion analysis data depending on treatment time after oxygen plasma penetration treatment of a pristine 1T-WS₂ metal catalyst according to an embodiment of the disclosure.

FIG. 13B shows surface polarity and dispersion analysis data depending on treatment time after oxygen plasma penetration treatment of a WSO-0.6 metal catalyst according to an embodiment of the disclosure.

FIG. 13C shows surface polarity and dispersion analysis data depending on treatment time after oxygen plasma penetration treatment of a WSO-1.2 metal catalyst according to an embodiment of the disclosure.

FIG. 13D shows surface polarity and dispersion analysis data depending on treatment time after oxygen plasma penetration treatment of a WSO-1.7 metal catalyst according to an embodiment of the disclosure.

### DETAILED DESCRIPTION OF THE INVENTION

Hereinafter, the disclosure will be described with reference to the accompanying drawings. However, the disclosure may be implemented in various different forms, and is not limited to the embodiments described herein. In the drawings, parts unrelated to the description are omitted to clearly describe the disclosure, and like numerals refer to like components throughout the specification.

Throughout the specification, when a part is referred to as being “connected (accessed, contacted, coupled)” to another part, not only it can be “directly connected” to the other part but it can also be “indirectly connected” to the other part via an intervening member. Further, when a certain part is referred to as “including” a certain component, this indicates that other components are not excluded but may be additionally included uncles otherwise noted.

The terms used in this specification are only used to describe specific embodiments, but not intended to limit the disclosure. Unless the context clearly dictates otherwise, singular forms include plural forms as well. In this specification, “it should be understood that term “include” or “have” indicates that a feature, a number, a step, an operation, a component, a part, or the combination thereof described in the embodiments is present, but does not preclude a possibility of presence or addition of one or more other features, numbers, steps, operations, components, parts or combinations thereof, in advance.

Below, the embodiments of the disclosure will be described in detail with reference to the accompanying drawings.

A metal catalyst with a vertical heterojunction interface will be described according to an embodiment of the disclosure.

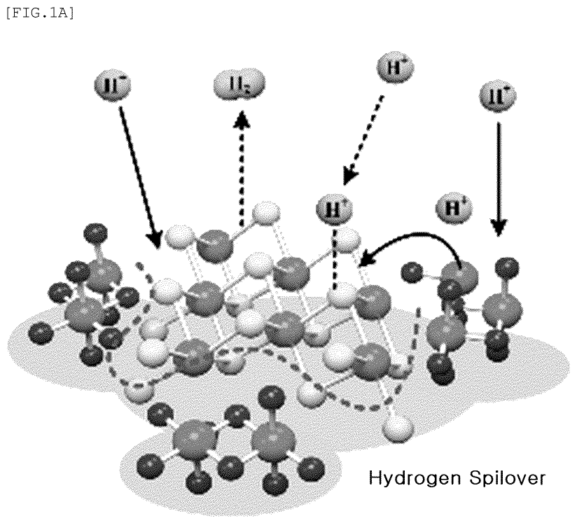

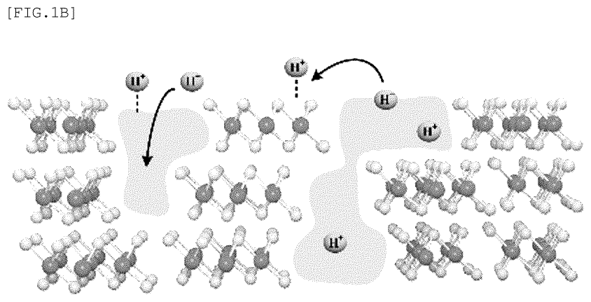

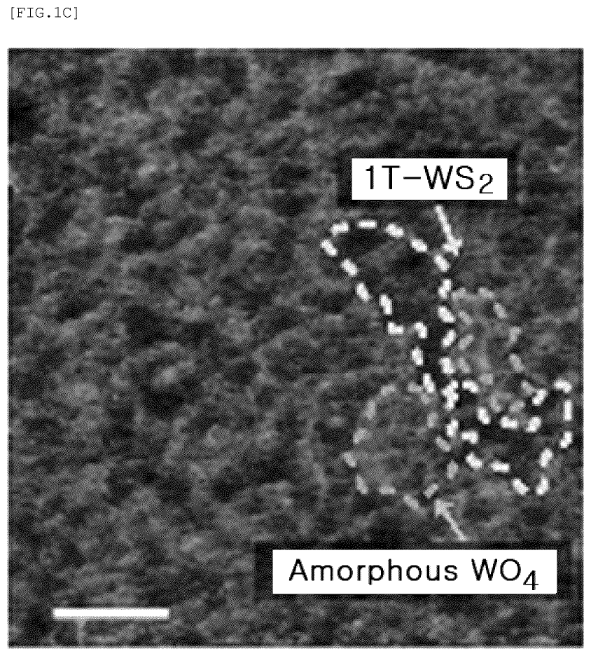

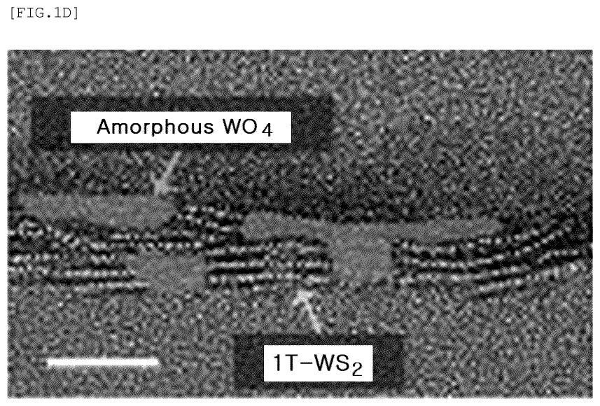

FIGS. 1A to 1D are schematic diagrams showing the structures of metal catalysts according to an embodiment of the disclosure.

Referring to FIG. 1, the metal catalyst according to an embodiment of the disclosure may include a nano-crystallized transition metal sulfide matrix having a layered structure; and an amorphous transition metal oxide located in a space between crystals of the transition metal sulfide matrix and heterogeneously bonded to the transition metal sulfide matrix.

Conventional catalyst materials capable of hydrogen spillover mainly include composite materials where precious metal (Pt, Ir, etc.) and a transition metal compound are combined. In this case, hydrogen is preferentially adsorbed onto the precious metal and then transferred to the surrounding transition metal compound. Because the precious metal materials are expensive, there are problems in commercializing and mass-producing the electrochemical catalysts. Accordingly, it is required to research and develop a new hybrid material with spillover characteristics, which is economical without containing the precious metal and exhibits high electrocatalyst performance. To solve the foregoing problems, the disclosure provides a metal catalyst with a heterojunction interface between the transition metal compounds.

First, there is provided a transition metal sulfide matrix according to the disclosure.

According to the disclosure, transition metal sulfide used herein has a nano-crystallized structure.

According to the disclosure, the transition metal sulfide matrix has a layered structure.

In this case, the layered structure may refer to a layered structure where two-dimensional layers are stacked.

The transition metal sulfide with the nano-crystallized structure has the same stoichiometric ratio as the contrasting material of 2H—WS₂ but has higher electrical properties due to structural difference, and may for example include 1T-WS₂ according to the disclosure.

In this case, the transition metal sulfide with the nano-crystallized structure according to the disclosure may have an octahedral (tetragonal, T), trigonal prismatic (hexagonal, H), or distorted phase (T′) crystal structure.

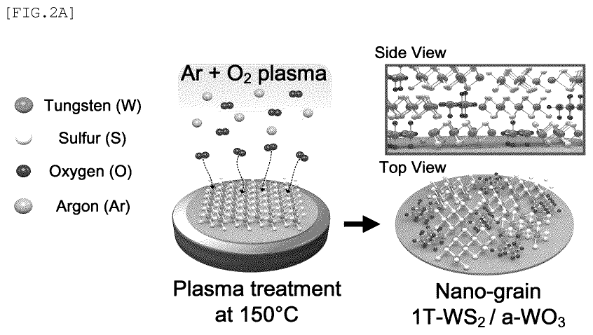

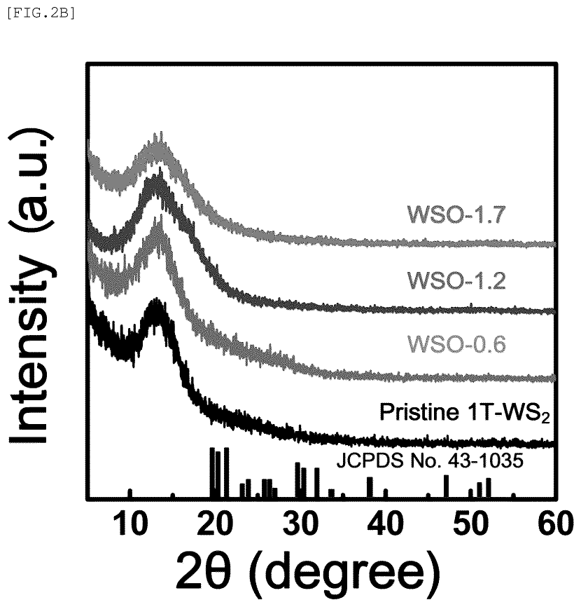

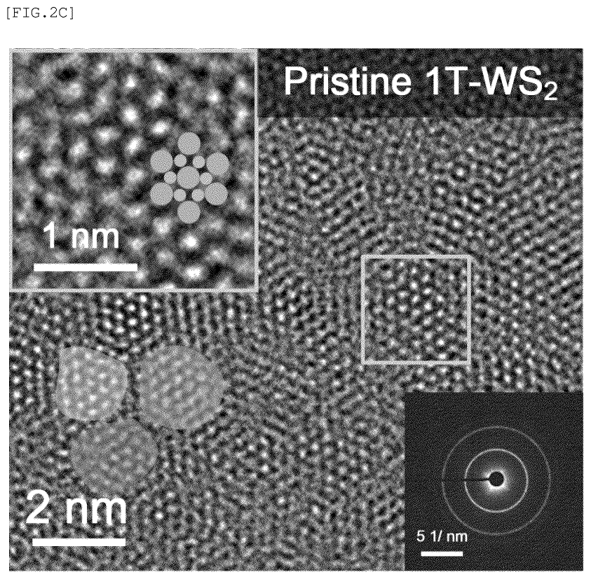

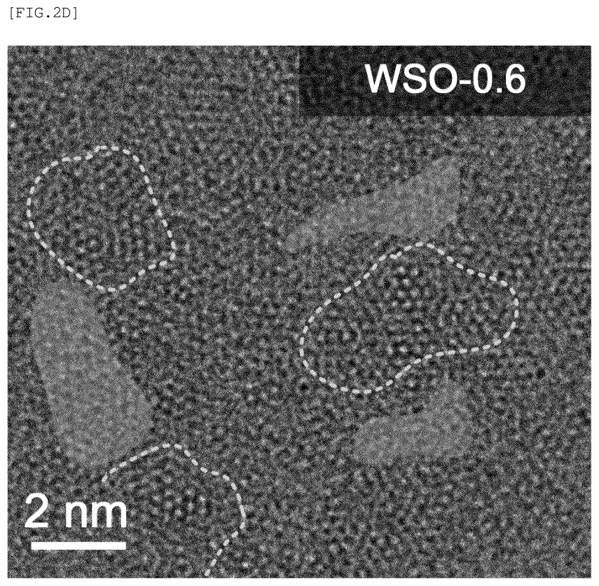

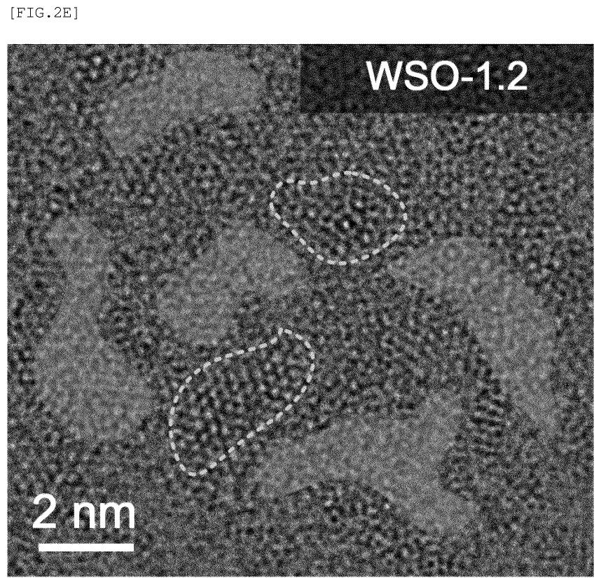

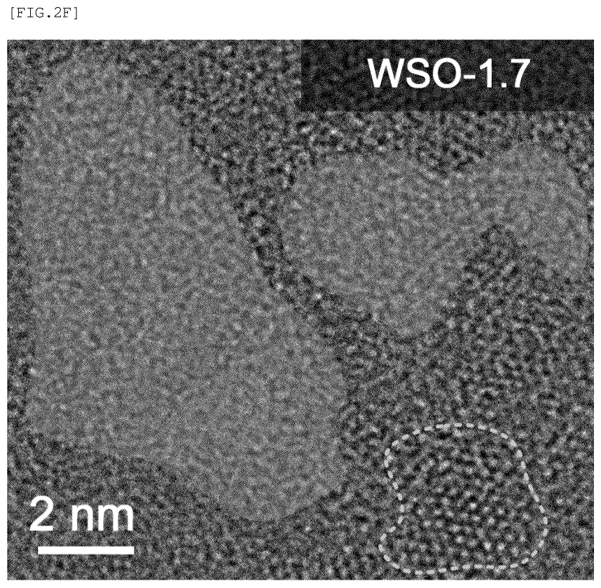

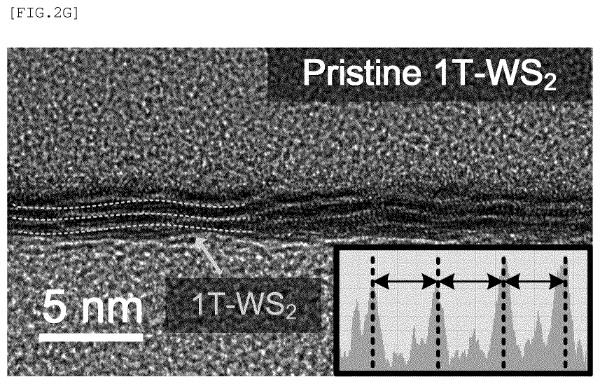

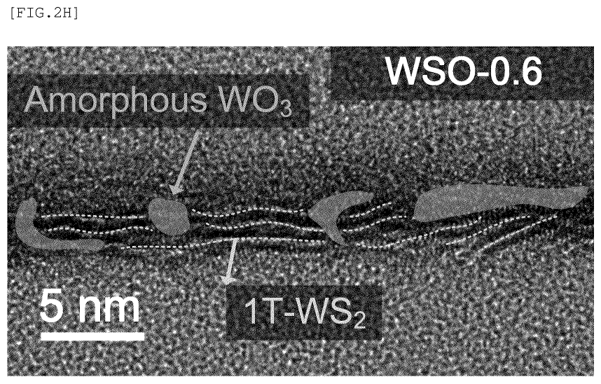

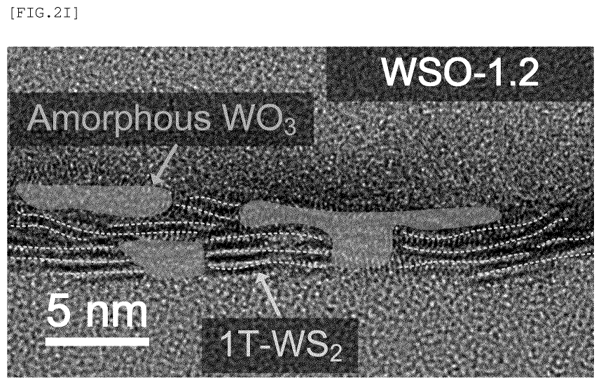

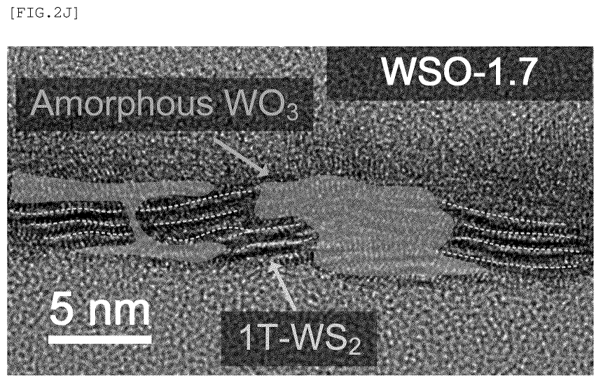

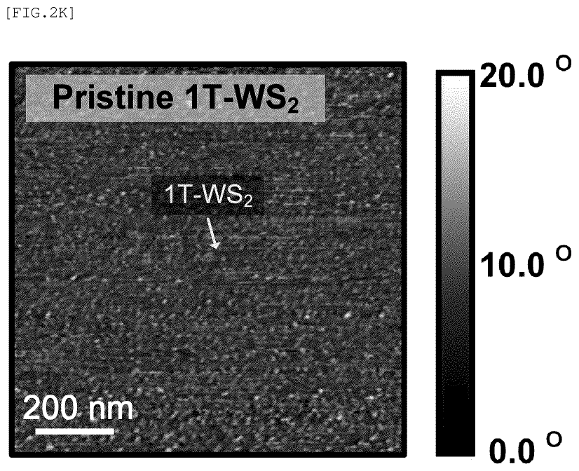

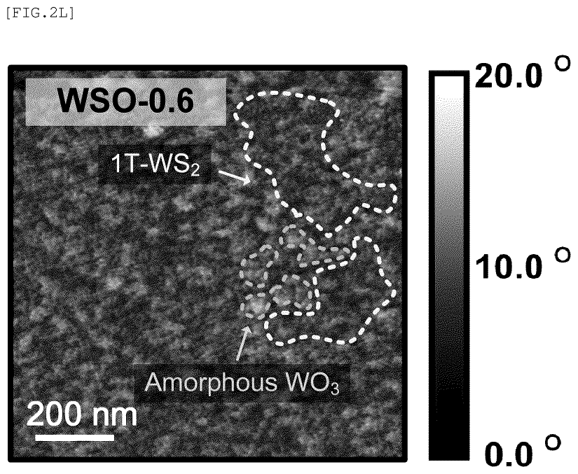

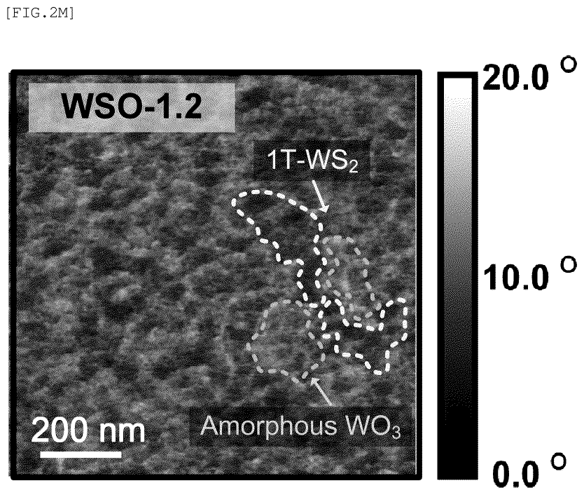

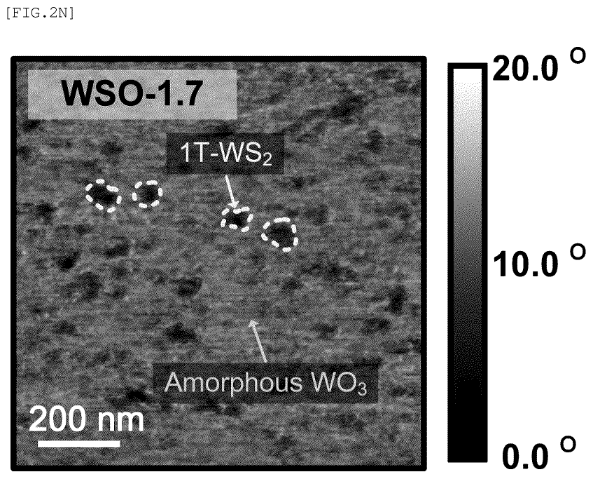

It is shown through transmission electron microscopy and selected area diffraction that the transition metal sulfide synthesized according to the disclosure was controlled to have a unit crystal size of about 5 to 10 nm and formed to have a polycrystalline structure with various orientations [see FIG. 2 C to F].

In this case, the polycrystalline structure generally has more defects than a monocrystalline structure and allows reactants to penetrate easily, and such defects facilitate hybridization with other materials.

The transition metal sulfide according to the disclosure has a nano-crystallized structure of about 5 to 10 nm, and has the polycrystalline structure with various orientations because it is observed as having a circular form when subjected to the selected area diffraction analysis.

In this case, when the polycrystalline structure has more electrochemical grain boundaries, the density of activated active sites increases, and transition metal oxides are easily formed at the defects of the transition metal sulfide.

The transition metal sulfide, of which a crystal domain is controlled at a level of several nanometers, can facilitate ion penetration of the transition metal oxide (to be described later).

Further, the unit crystal size in a framework of the transition metal sulfide according to the disclosure is controlled at a nanometer scale level. When the unit crystal size in the framework is controlled at the nanometer scale level, the transition metal sulfide may facilitate ion penetration of the transition metal oxide based on the principles of penning ionization by argon inert gas, ion bombardment by argon inert gas, and subsequent ion penetration of ionized hydrogen sulfide.

In this case, the transition metal sulfide has a unit crystal size of 5 nm to 10 nm in the framework structure.

Further, the transition metal sulfide matrix according to an embodiment of the disclosure may include one or more selected from a group consisting of WS₂, MoS₂, VS₂, TiS₂, ReS₂, NiS₂, CoS₂ and TaS₂, which exhibit high catalytic activities for a hydrogen evolution reaction.

The transition metal sulfide may include any material as long as it has superior electrochemical activity as an alternative material that overcomes limitations to industrialization the electrocatalysts based on the precious metal has.

Further, the transition metal sulfide according to an embodiment of the disclosure may be deposited on a wafer by an electron beam evaporator. In this case, the transition metal sulfide may be deposited in 4 to 8 layers.

In this case, the 4 to 8 layers may be reformed by the sulfurization treatment and the oxidation treatment. Here, the reformed 4 to 8 layers are the optimal thickness to participate in a reaction because the hydrogen evolution reaction is a surface reaction.

In this case, the deposited transition metal sulfide may have a total thickness of 10 nm to 20 nm.

The reason why the transition metal sulfide is deposited in multiple layers as above is to maximize a reaction active site, in which a hydrogen spillover phenomenon occurs, when an vertical heterogeneous interface of an oxide is introduced into the uniform transition metal sulfide.

Further, there is provided an amorphous transition metal oxide according to the disclosure.

Conventionally, transition metal sulfides have superior catalyst activities but poor hydrogen adsorption properties, and transition metal oxides have superior hydrogen adsorption properties but poor catalyst activities.

To solve the above problems, there is a need for introducing/forming the heterojunction interface uniformly in order to complement the shortcomings of the transition metal sulfide and the transition metal oxide as the electrocatalysts, and maximize a specific hydrogen spillover phenomenon that occurs at the heterojunction interface between the transition metal sulfide and the transition metal oxide.

According to the disclosure, the crystalline transition metal sulfide used herein has inherently high stability, and has limitations to structural control and structural modification due to difference in a lattice structure from a newly introduced material when the heterojunction interface is introduced.

Therefore, the amorphous transition metal oxide according to an embodiment of the disclosure is located in a space between the crystals of the transition metal sulfide matrix, and the amorphous transition metal oxide and the transition metal sulfide matrix are heterogeneously bonded, in which the amorphous transition metal oxide formed to penetrating the transition metal sulfide matrix in a vertical direction, thereby forming a vertical interface between the transition metal sulfide matrix and the amorphous transition metal oxide.

The transition metal sulfide matrix has the nano-crystallized structure of the layered structure, and oxygen plasma may cause defects to be formed in the inner crystals of the transition metal sulfide matrix deposited on the wafer, so that the amorphous transition metal oxide can be vertically formed in the interface of the transition metal sulfide matrix by the ion penetration between the formed defects.

The metal catalyst produced according to an embodiment of the disclosure refers to a metal catalyst with the heterojunction interface introduced by vertically forming the amorphous transition metal oxide on the interface of the transition metal sulfide matrix. When the heterojunction interface is vertically formed, it is possible to solve the conventional problem that the hydrogen spillover phenomenon of improving the electrochemical activities is limited only to the surface due to the oxide film formed only on the surface.

Further, it is possible to solve the conventional problem that the oxide film not bonded to the transition metal sulfide degrades the electrical properties of the material and decreases the electrochemical activities.

In this case, the transition metal sulfide matrix and the transition metal oxide may be mixed at a stoichiometric ratio of 1:0.6 to 1:1.7.

The reason why the mixing ratio of the transition metal sulfide matrix to the transition metal oxide is at 1:0.6 to 1:1.7 is because a transition reaction of hydrogen from oxide to sulfide is weakened when the mixing ratio is lower than 1:0.6, and an oxide layer having electrically insulating properties is excessively formed to degrade the electrical conductivity and decrease the catalytic activities when the mixing ratio is higher than 1:1.7.

In this case, the vertical heterojunction interface between the transition metal sulfide matrix and the amorphous transition metal oxide has a length of 2 nm to 5 nm, and a horizontal heterojunction interface therebetween has a length of 5 nm to 10 nm.

In this case, when the length of the interface where the transition metal sulfide matrix and the amorphous transition metal oxide are heterogeneously bonded is shorter than 10 nm, hydrogen adsorption is not smoothly performed. On the other hand, when the length of the interface is longer than 20 nm, oxide may be formed more largely than sulfide corresponding to a reaction area.

In this case, for example, the interface has a vertical length of about 3 nm based on a cross-sectional analysis, and a horizontal length shorter than or equal to 100 nm based on a surface analysis.

According to the disclosure, the transition metal compound used herein may include an amorphous transition metal compound. The reason why the amorphous transition metal compound is used is because amorphous disordered atomic arrangement enables smooth penetration of ion reactants into a catalyst active site in a solution and thus has an effect on exhibiting high ionic conductivity and catalyst activity.

Further, the amorphous transition metal oxide may include one or more selected from a group consisting of WO₃, MOO₃, V₂O₅, TiO₂, ReO₂, NiO₂, CO₃O₄ and TiO₂.

In this case, the amorphous transition metal oxide may include any material as long as it has strong resistance to a specific acid solvent usable in a catalyst reaction.

Therefore, the metal catalyst with the vertical heterojunction interface according to an embodiment of the disclosure allows hydrogen adsorbed on the transition metal oxide to be transferred to the transition metal sulfide (hydrogen spillover phenomenon), thereby having superior hydrogen adsorption performance and excellent catalyst activity.

Below, a method of producing a metal catalyst with a vertical heterojunction interface according to another embodiment of the disclosure will be described.

The method of producing a metal catalyst with a vertical heterojunction interface according to another embodiment of the disclosure may include the steps of: depositing a transition metal thin film having a nanometer thickness on a wafer; preparing a wafer, on which a surface-treated transition metal thin film is deposited, by injecting the wafer formed with the transition metal thin film into a plasma chemical vapor deposition device and then removing a natural oxide film from the transition metal thin film formed on the wafer through hydrogen plasma treatment; preparing a nano-crystallized transition metal sulfide matrix by heating the wafer, on which the surface-treated transition metal thin film is deposited, to a preset first temperature under an inert gas atmosphere and then adding inert gas and hydrogen sulfide gas and performing the plasma treatment to cause a sulfidation reaction by ion penetration on the surface-treated transition metal thin film; and preparing a metal catalyst with an amorphous transition metal oxide heterogeneously bonded between crystals of the nano-crystallized transition metal sulfide matrix by subjecting the nano-crystallized transition metal sulfide matrix to oxygen plasma treatment at a preset second temperature under an atmosphere of oxygen gas and inert gas for a preset period of time.

The first step may include depositing a transition metal thin film having a nanometer thickness on a wafer.

According to the disclosure, the transition metal thin film is deposited by a nanometer thickness under high vacuum conditions in an electron beam evaporator.

In this case, the transition metal thin film may be deposited to have a thickness of 1 nm to 2 nm.

The reason why the transition metal thin film is deposited to have a thickness of 1 nm to 2 nm is because the thickness of a thin film is required to be thin to synthesize an appropriate transmission metal compound by a sulfidation method using low-temperature plasma processing technology.

In this case, according to the disclosure, the transition metal thin film may be stacked in 4 to 8 layers to have a total thickness of 3 nm to 10 nm.

The second step may include preparing a wafer, on which a surface-treated transition metal thin film is deposited, by injecting the wafer formed with the transition metal thin film into a plasma chemical vapor deposition device and then removing a natural oxide film from the transition metal thin film formed on the wafer through hydrogen plasma treatment.

In this case, the hydrogen plasma treatment may be performed for 15 minutes under an atmosphere of 200 W and 200 mTorr.

The third step may include preparing a nano-crystallized transition metal sulfide matrix by heating the wafer, on which the surface-treated transition metal thin film is deposited, to a preset first temperature under an inert gas atmosphere and then adding inert gas and hydrogen sulfide gas and performing the plasma treatment to cause a sulfidation reaction by ion penetration on the surface-treated transition metal thin film.

In this case, the internal temperature of the plasma chemical vapor deposition device may be raised up to 150 degrees under inert gas conditions, and then a mixed gas of Ar and H₂S may be injected through a nozzle for 90 minutes at a flow rate of 10 standard cc per minute (sccm).

Next, HAS gas ionized through penning ionization may transform a metal thin film (e.g., W) previously formed by ion bombardment or ion penetration into a transition metal sulfide (e.g., WS₂).

In this case, the transition metal sulfide (e.g., WS₂) has a nanocrystalline structure and thus enables smooth oxygen ion penetration thereinto during the subsequent oxygen plasma treatment.

Further, the preset first temperature may range from 100° C. to 150° C.

In this case, at the temperature of 100° C. to 150° C., it is possible to control the heterojunction interface to a several nanometer level by the ion penetration using a low-temperature plasma reaction.

The fourth step may include preparing a metal catalyst with an amorphous transition metal oxide heterogeneously bonded between crystals of the nano-crystallized transition metal sulfide matrix by subjecting the nano-crystallized transition metal sulfide matrix to oxygen plasma treatment at a preset second temperature under an atmosphere of oxygen gas and inert gas for a preset period of time.

According to the disclosure, a low-temperature process is necessary for controlling the excessive formation of the oxide film.

In this case, thermal energy necessary for causing an oxidation reaction is required to be effectively controlled in order to introduce the oxide film through the low-temperature process, and thus the low-temperature process is inevitable.

In this case, the penetration of reactant oxygen plasma is required to be smoothly performed in order to introduce a uniform oxide junction interface. To this end, the crystalline structure of the transition metal sulfide (e.g., WS₂) is limited to a nanoscale level, and the penetration of oxygen plasma into the crystalline structure is maximized, thereby introducing the uniform transition metal oxide interface.

In other words, Ar and O₂ are simultaneously injected into a substrate at a preset temperature so that physical collision of Ar and chemical bonding between the transition metal oxide and O₂ are performed at the same time, thereby forming the heterojunction interface between the transition metal sulfide and the transition metal oxide as a nanoscale vertical heterojunction interface.

Further, the amorphous transition metal oxide and the transition metal sulfide matrix are heterogeneously bonded, in which the amorphous transition metal oxide is formed penetrating the transition metal sulfide matrix in a vertical direction, thereby forming a vertical interface.

In this way, according to the disclosure, the uniform heterojunction interface between the uniform transition metal sulfide and the transition metal oxide is controlled at a several nanometer level by the ion penetration reaction based on the low-temperature plasma technology, and the hydrogen spillover phenomenon, which has locally occurred only in the interface due to the limitations to the formation of the conventional completely separated heterojunction interface, is expandable up to the entire system.

In this case, the oxygen plasma treatment is performed for 30 seconds to 90 seconds.

When the oxygen plasma treatment is performed for less than 30 seconds, the oxide may not be formed. On the other hand, when the oxygen plasma treatment is performed for more than 90 seconds, the entire sulfide surface may be formed as the oxide.

Further, the preset second temperature may range from 100° C. to 150° C.

In this case, when the second temperature is lower than 100° C., a substitution reaction between sulfur and oxygen atoms in the previously deposited transition metal sulfide may not occur smoothly. On the other hand, when the second temperature is higher than 150° C., the oxide may be excessively formed, thereby causing a problem of forming a framework where the interface between the sulfide and the oxide is completely separated from. Therefore, the oxygen plasma treatment temperature is set to 100° C. to 150° C.

Therefore, the method of producing the metal catalyst with the vertical heterojunction interface employs the ion penetration reaction based on the low-temperature plasma treatment technology, thereby having effects on n controlling the heterojunction interface between the transition metal sulfide and the transition metal oxide to a nanometer level and forming the interface uniformly.

Below, the disclosure will be described in detail with reference to Preparation Examples and Experiment Examples. These Preparation Examples and Experiment Examples are merely for illustrating the disclosure, and the scope of the disclosure is not limited by these Preparation Examples and Experiment Examples.

### Preparation Example 1: Preparation of WS₂/WO₃ Metal Catalyst (WSO)

First, a tungsten (W) thin film metal seed layer was deposited on a 4-inch SiO₂/Si wafer by e-beam deposition.

Next, the wafer on which the tungsten thin film was deposited was placed in a PE-CVD chamber, treated with H₂ plasma for 10 minutes to remove natural oxide, and then heated to 300° C. under Ar purging.

Next, the wafer formed with the W thin film was subjected to a sulfidation reaction with a mixed gas of Ar and H₂S (v/v=1/1) at 150° C. for 90 minutes, thereby preparing a nano-crystallized tungsten sulfide (1T-WS₂) matrix.

Next, O₂ gas and Ar gas were injected into the same PE-CVD chamber, and the oxygen plasma treatment was performed with the O₂ gas (15 sccm) and the Ar gas (5 sccm) at the power of 50 W for oxidation, thereby preparing a metal catalyst with an amorphous tungsten oxide (a-WO₃) located in a space between crystals of the nano-crystallized transition metal sulfide matrix and heterogeneously bonded to the interface of the transition metal sulfide matrix in a vertical direction.

In this case, the chamber was evacuated to a vacuum of 200 mTorr, and the treatment was performed at 150° C.

The experiments for checking the synthesis and electrochemical bonding structure of the WS₂/WO₃ metal catalyst (WSO) according to an embodiment of the disclosure will be described with reference to FIGS. 2 to 13.

In the Experiment Examples, WSO refers to the WS₂/WO₃ metal catalyst, 1T-WS₂ refers to a nano-crystallized tungsten sulfide, and WO₃ refers to an amorphous transition metal oxide.

### Experiment Example 1: An Analysis of the Surface and Cross-Sectional Characteristics of the WS₂/WO₃ Metal Catalyst (WSO)

FIG. 1C is an atomic force microscope (AFM) image of a metal catalyst according to an embodiment of the disclosure.

FIG. 1D is a high-resolution transmission electron microcopy (HRTEM) image of a metal catalyst according to an embodiment of the disclosure.

Further, FIG. 2A is a schematic diagram of a PE-CVD-based synthesis process for a WSO heterogeneous structure, FIG. 2B shows X-ray diffraction (XRD) patterns of different WSO samples, FIGS. 2C to 2F show HR-TEM images of a WSO thin film according to different periods of time for the plasma treatment (1T-WS₂ in FIG. 2C, WSO-0.6 for 30 seconds in FIG. 2D, WSO-1.2 for 60 seconds in FIG. 2E, and WSO-1.7 for 90 seconds in FIG. 2F), FIGS. 2G to 2J are cross-sectional images of FIGS. 2C to 2F, and FIGS. 2K to 2N show images of pristine 1T-WS₂ and WSO thin film phases. In FIGS. 2K to 2N, the domain surrounded by the yellow dotted line corresponds to the 1T-WS₂ stage, and the light blue shaded area corresponds to an a-WO₃ stage.

FIG. 2A shows the subsequent process of the oxygen (O₂) plasma treatment to form a patchwork structure by partially transforming a 1T-WS₂ layer into a WSO film containing WO₃.

Referring to FIG. 2A, the 1T-WS₂ layer and the samples were treated with the oxygen (O₂) plasma for 30, 60 and 90 seconds, thereby making the ratios of 1T-WS₂ and a-WO₃ phases as WSO-0.6, WSO-1.2 and WSO-1.7.

In this case, WSO-0.6, WSO-1.2 and WSO-1.7 mean that the mixing stoichiometric ratios of the tungsten sulfide (1T-WS₂) matrix and the tungsten oxide (a-WO₃) are 1:0.6, 1:1.2, and 1:1.7, respectively.

FIG. 2B shows results of examining the crystallographic conditions of the samples, which have been treated by plasma, using the XRD analysis.

Referring to FIG. 2B, diffraction peaks corresponding to the plane of monoclinic WO₃ (JCPDF no. 43-1035) were not observed in any of the pristine 1T-WS₂ and WSO films, which means that WO₃ was formed in an amorphous layer.

In other words, the XRD analysis indicates that new peaks were not formed for each process, which may mean that the synthesized transition metal oxide is amorphous.

In addition, the observed wide peaks of 30° or below may indicate that the synthesized 1T-WS₂ and WSO were formed having nanosized domains based on transmission electron microscopy (TEM) images.

Below, the Phases of the Heterojunction Metal Catalysts after the Oxygen Plasma Treatment Will be Described.

As HR-TEM surface analyses, FIGS. 2C to 2F show analysis images of surface crystal changes of the 1T-WS₂ thin film depending n a penetration time of oxygen plasma, and, specifically, show the HR-TEM surface analyses of pristine 1T-WS₂ (FIG. 2C), WSO-0.6 (FIG. 2D), WSO-1.2 (FIG. 2E), and WSO-1.7 (FIG. 2F)

An electron diffraction pattern of a selected area in the 1T-WS₂ film shown in FIG. 2C has two separated ring patterns corresponding to (100) and (110) planes, which indicate phases determined by fast Fourier transform (FFT) and TEM images in a color domain.

Referring to FIGS. 2C to 2F, it will be understood that the amount of oxide bonding interfaces introduced into the transition metal sulfide increases according to oxygen plasma treatment time.

Further, FIG. 2G shows that three or four 1T-WS₂ layers are stacked with a space of 0.65 nm therebetween.

Further, FIGS. 2H to 2J show cross-sectional TEM images of the WSO film according to various degrees of plasma oxidation.

In FIGS. 2H to 2J, the amorphous tungsten oxide area is shown in blue and gradually expands as the oxygen (O₂) plasma treatment time increases.

Referring to FIGS. 2H to 2J, it will be understood that the 1T-WS₂ surface is randomly filled with the transition metal oxide (a-WO₃) area to form the heterogeneous interface having a patchwork structure between the two stages.

In other words, the observed cross-sections show that a-WO₃ was not only laterally grown but also vertically interpenetrated the stacked 1T-WS₂ layers.

Further, the formation of the heterogeneous interface between 1T-WS₂ and WO₃ may gradually expand within the film due to enhanced oxygen radical penetration as the oxygen (O₂) plasma treatment time increases.

Below, the Characteristics that Appear During the Oxidation Process Based on the Oxygen Plasma Treatment Will be Described.

FIGS. 2K to 2N show the results of AFM measurement for analyzing the surface phases of the 1T-WS₂ thin film depending on the penetration time of oxygen plasma.

The oxygen (O₂) plasma treatment facilitates the introduction of bonding with the transition metal oxide and prevents the WSO samples from destruction.

However, referring to FIGS. 2K to 2N, the AFM phase images show that continuous oxygen (O₂) plasma treatment results in gradual change from a brown area (weak friction) to a larger bright area (strong friction) due to a phase shift.

Considering that the surface characteristics varied depending on the chemical composition, friction (adhesion), and rigidity of the samples are inferable using such phase difference, a-WO₃, which is more hydrophilic than 1T-WS₂, is formed by the O₂ plasma treatment and causes stronger friction in phase mode AFM observation.

Therefore, it will be understood that a-WO₃ was introduced from the bright area observed in the AFM phase images. Thus, the 1T-WS₂/WO₃ (WSO) is implemented to have high activities with the proton transport properties of a-WO₃.

### Experiment Example 2: A Chemical Bond Analysis of the WS₂/WO₃ Metal Catalyst (WSO)

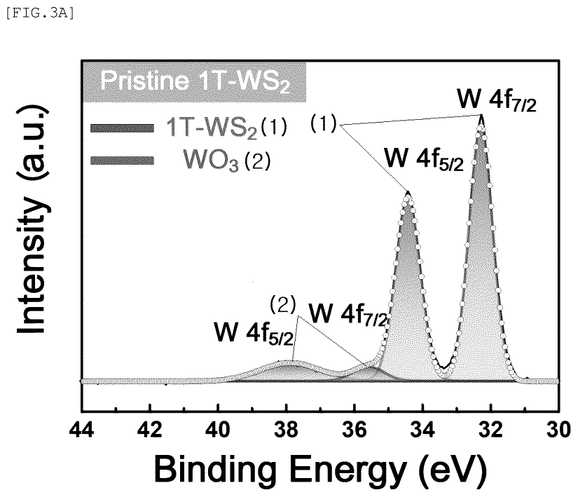

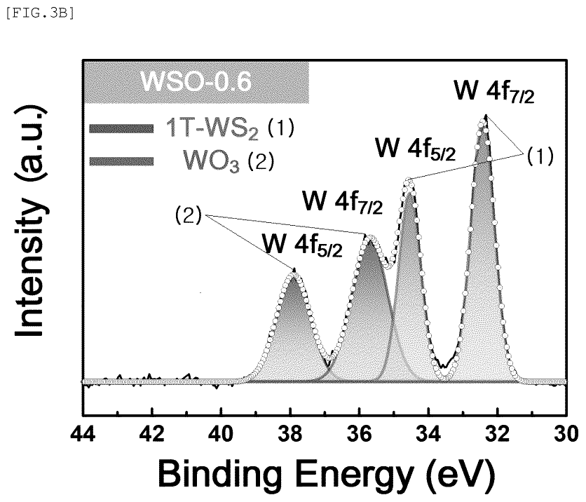

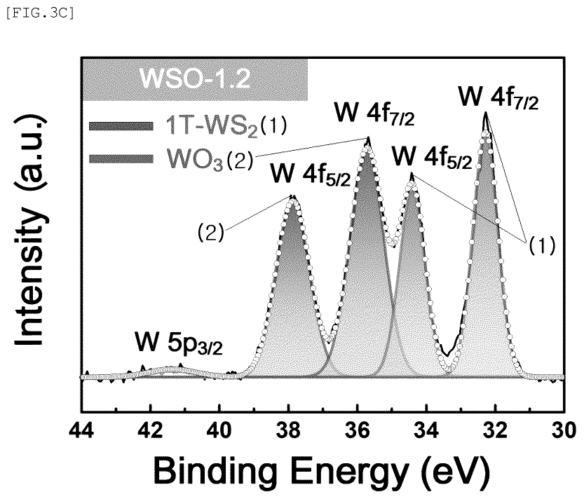

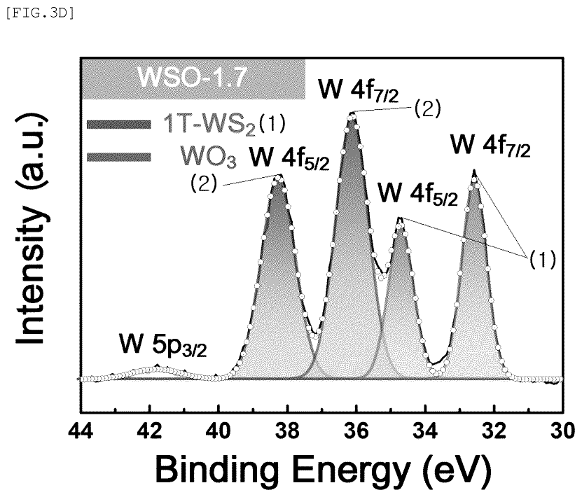

FIGS. 3A to 3D are graphs showing chemical bond analysis results of the metal catalysts according to an embodiment of the disclosure depending on a penetration time of oxygen plasma.

The graphs of FIG. 3, which were obtained from XPS measurements of different samples, show the W-4f spectrum peaks before and after treating the WS₂ film with oxygen plasma.

Referring to FIGS. 3A to 3D, the recorded W⁶⁺ peaks were 35.27 eV (W⁶⁺ 4f_{7/2}) and 37.58 eV (W⁶⁺ 4f_{5/2}) as the plasma treatment time increases, and it is thus understood that the indicator of WO₃ phase is much wider and stronger than the pristine 1T.

Likewise, it is also understood that a general WO bond at 530.9 eV based on the O 1s peak on WO₃ becomes gradually stronger as the oxygen treatment time increases.

Therefore, a relative composition between 1T-WS₂ and a-WO₃ are changed as the oxygen (O₂) plasma treatment time increases, which may be examined by comparing the area ratio of the XPS spectrum peaks.

In this case, the total and polar component values of the surface energy was increased as the oxygen (O₂) plasma treatment time increases, but the non-polar component values of the surface energy may decrease.

Naturally, the formation of hydrophilic a-WO₃ contributes to improvement in the wettability of the WSO thin film surface having polarity.

The XPS spectrum analysis shows that the proportion of a-WO₃ increases more as the plasma treatment time increases than that of 1T-WS₂.

In this case, the introduction of the heterogeneous interface may be attributed to the increase of the polar surface energy having the hydrophilicity, which is because the internal structure edges of a two-dimensional transition metal group compound (TMDC) need to interact strongly with the polar components ad previously reported.

### Experiment Example 3: A Hydrogen Spillover Material Mechanism Analysis Using Cyclic Voltammetry (CV) Measurement of the WS₂/WO₃ Metal Catalyst (WSO)

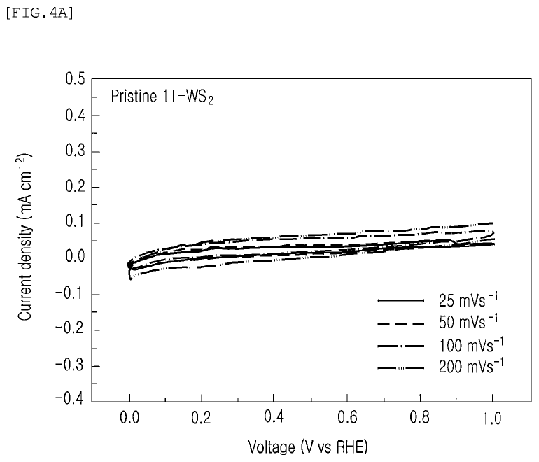

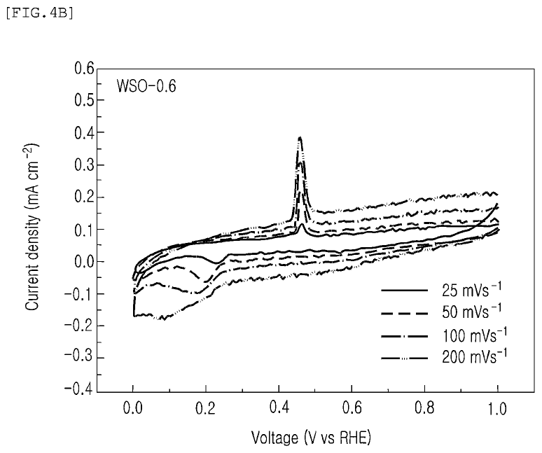

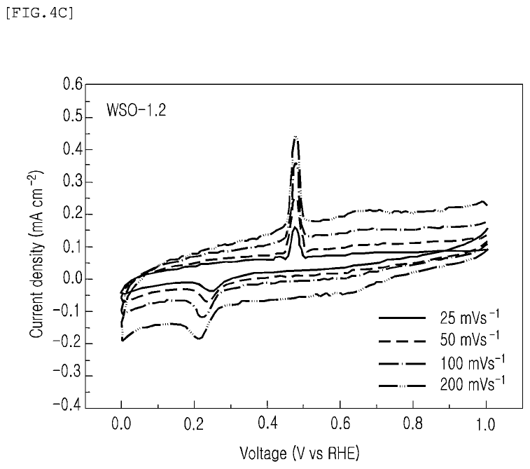

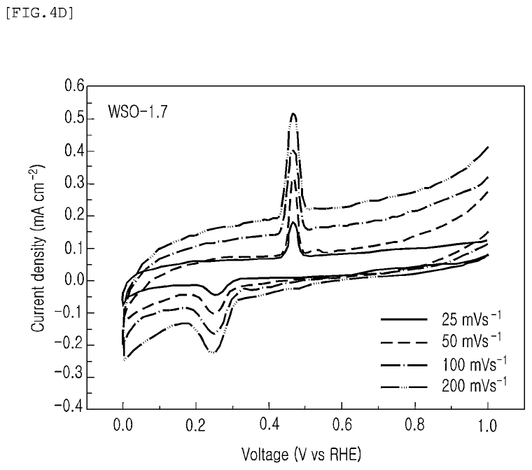

FIGS. 4A to 4D are graphs showing hydrogen spillover material mechanism analyses based on CV measurement of metal catalysts according to an embodiment of the disclosure.

It has been reported that the wettability of a material due to surface energy directly affects the density of water molecules or ions in electric double layer (EDL) capacitance. As a result, the 1T-WS₂-a-WO₃ interface was successfully introduced by the O₂ plasma treatment. Here, proton adsorption is more easily generated by hydrophilic WO₃.

In this Experiment Example, various electrochemical measurements were performed to determine the hydrogen evolution reaction (HER) catalyst kinetics and hydrogen spillover effect (HSE) of the interface WSO thin film.

Cyclic voltammetry (CV) was measured to examine the synergistic effect of the transition metal sulfide and the transition metal oxide.

Referring to FIGS. 4A to 4D, the role of WO₃ was examined through the CV by generating the negative/positive electrode peaks related to the insertion or extraction of protons.

In this case, the CV may be performed at four different scanning rates in 0.5 M of an H₂SO₄ electrolyte.

A CV profile may show the presence of a-WO₃ capable of accelerating the insertion of protons and the role of HₓWO₃ transferring the protons to the catalyst in the HER process.

In this case, the shift of oxidation and reduction peaks according to the different scanning rates may be interpreted as a delayed reaction time for the proton adsorption to reach the maximum current density.

A delayed voltage of WSO-0.6 measured at 25 to 200 mVs⁻¹ was 3.2 mV, and it is thus understood that WSO-0.6 has lower kinetics of the proton adsorption than WSO-1.2 and WSO-1.7.

This may mean that WSO-1.7 responds to the proton adsorption relatively faster than WSO-0.6 and WSO-1.2.

Thus, a-WO₃ can serve as a proton channel that promotes the transfer of protons to WO₃.

As shown in FIGS. 2H to 2J, it is observed that the formation of WO₃ vertically stacked inside the WS₂ layers is accelerated as the oxygen (O₂) plasma treatment time increases.

The proton penetration in the lower layers may be hindered by the upper WS₂ crystal layers, and thus change from the nanocrystal 1T-WS₂ to a-WO₃ may improve proton accessibility.

Therefore, the effective proton insertion in the lower a-WO₃ may be hindered by the upper WS₂.

The response time delay of WSO-0.6 may be caused by the inefficient formation of WO₃ embedded in the WS₂ layer required to serve as the proton channel for the lower WO₃.

Due to the inefficient proton channel, slow proton mass transport to the lower WO₃ layer causes the current density in the lower WO₃ layer to be measured low in the CV measurement.

As a result, the proton mass transport to the bottom layer of the synthesized catalyst becomes faster from WSO-0.6 toward WSO-1.7, which leads to faster reactions to WSO-1.2 and 1.7 compared to WSO-0.6.

In other words, in terms of the negative electrode current density varied depending on the O₂ plasma treatment time due to the increasing concentration of the embedded protons, the relatively low current density of WSO-0.6 indicates that there are not many protons adsorbed to WSO-0.6 compared to other samples. On the other hand, the proton adsorption to WSO-1.2 and WSO-1.7 was significantly improved.

### Experiment Example 4: An Analysis of the Electrochemical Characteristics and Stability of the WS₂/WOs Metal Catalysts (WSO)

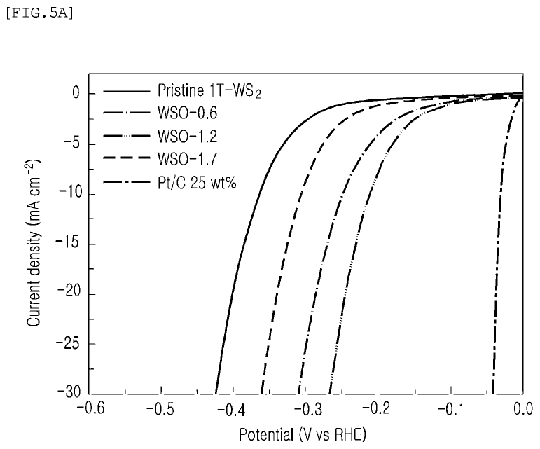

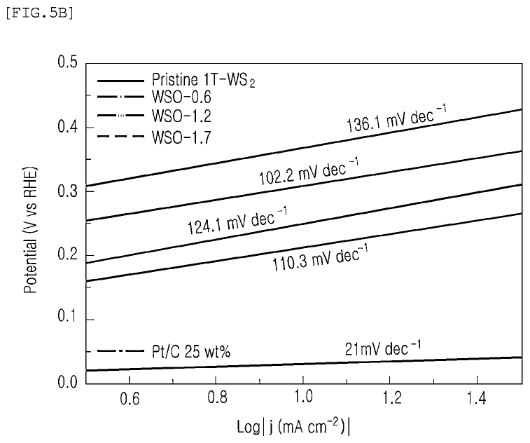

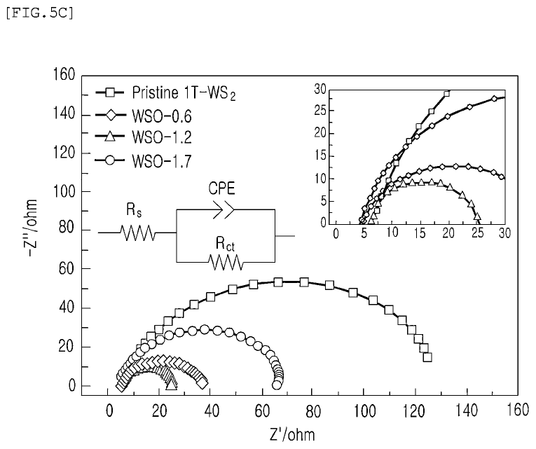

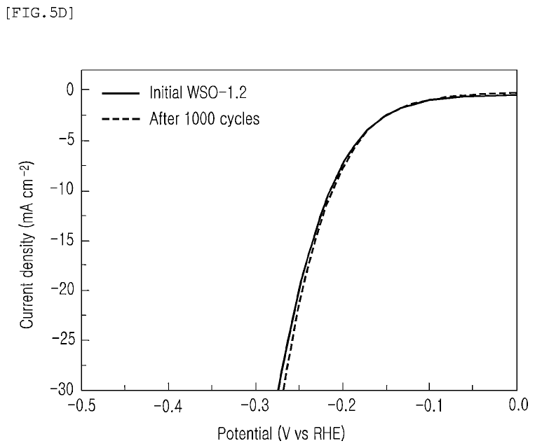

FIGS. 5A to 5D are graphs showing an electrochemical property evaluation and a stability analysis based on HER measurement of metal catalysts according to an embodiment of the disclosure.

In this Experiment Example, the electrochemical analysis of the WS₂/WO₃ metal catalyst (WSO) samples was performed using three electrode cells in 0.5 M of an H₂SO₄ electrolyte to analyze the hydrogen evolution reaction (HER) performance related to the hydrogen spillover effect (HSE).

Referring to FIGS. 5A to 5D, the HER activities of WSO in the electrode may be compared by plotting them as functions of potential versus reversible hydrogen electrode (RHE) as shown in FIG. 5A.

FIG. 5A shows that the catalyst performance of the 1T-WS₂ thin film treated with oxygen (O₂) plasma for 60 seconds was gradually improved, in which WSO-1.2 exhibited the best performance, and potential of 212 mV is required to achieve the current density of 10 mAcm⁻².

The a-WO₃ portion expanded in the catalyst due to the strong oxidation treatment serves as a proton storage and encourages more protons to participate in the HER.

However, the excessive oxidation of the WSO-1.7 due to a long oxygen (O₂) plasma treatment time may degrade the HER performance by an overvoltage of 308 mV at 10 mAcm⁻² because major components are changed from active WS₂ to inactive WO₃ HER.

In this case, in the case of WSO-1.7, protons abundantly adsorbed on the a-WO₃ were transferred to a WS₂ active site even though the expanded a-WO₃ exhibits fast HSE kinetics and enhanced proton mass transport.

On the other hand, in the case of WSO-1.2, overpotential may be largely decreased even though the amount of WO₃ is greater than that of WS₂.

Change from WS2 itself to WO₃ may not directly lead to the decrease in the WS₂ active site because additional WS₂ active sites may be induced by WO₃ defects and increase the number of newly exposed surfaces. Therefore, WO₃ may be introduced without affecting the number of WS₂ active sites.

However, the HER overpotential of WSO-1.7 may have a lower hydrogen spillover effect (HSE) than the pristine 1T-WS₂.

In FIGS. 5A to 5D, electrochemical impedance spectroscopy (EIS) measurements were performed to characterize the interface kinetics between the electrode and the acidic electrolyte during the HER process.

Further, Nyquist plots with semicircles show that the bulk electrolyte resistance (Rs, ≈5±0.5Ω) is similar for all cases, but the pristine 1T-WS₂ subjected to no oxygen (O₂) plasma treatment has the highest charge transfer resistance (Rct) compared to other samples.

In this case, referring to FIG. 5C, the Rct is related to the evolution of hydrogen at the interface, and the Rct at 400 mV relative to the RHE overvoltage may be decreased from 118.4 Ωcm² for the pristine 1T-WS₂ to 19.85 Ωcm² for WSO-1.2.

Further, it may also be observed that the Rct for WSO-1.7 increases to 61.02 Ωcm².

Further, a relatively low Rct may be related to the formation of hydrogen tungsten bronze and the proper transport of protons to an 1T-WS₂ active site having high electrical conductivity and acting as an HER catalyst.

In this case, the durability of WSO-1.2 was tested using long-term CV as shown in FIG. 5D.

The HER performance of the samples after 1000 cycles is almost the same as that in the initial state, and therefore it will be understood that WSO-1.2 exhibits consistent performance because tungsten trioxide has excellent thermodynamic stability in acidic solutions.

### Experiment Example 5: A DFT Analysis of the WS₂/WO₃ Metal Catalysts (WSO)

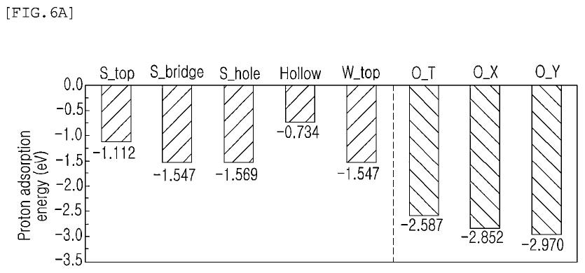

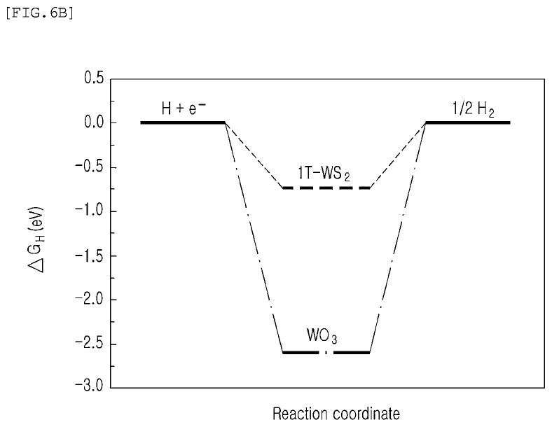

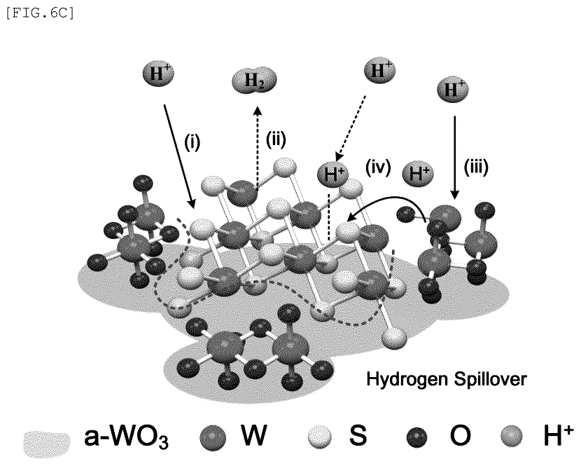

FIGS. 6A to 6C show density functional theory (DFT) analysis results of metal catalysts according to an embodiment of the disclosure.

In this Experiment Example for describing the HER mechanism in more detail, DFT calculations were performed to evaluate (i) relative proton adsorption capacity and (ii) the HER performance on 1T WS₂ and WO₃ phases, respectively.

First, adsorption sites for estimating the proton adsorption energy for each catalyst surface were defined.

As a result, FIG. 6A shows the Gibbs free energy of proton adsorption for each adsorption site of 1T-WS₂ and WO₃ phases.

In particular, in the 1T-WS₂ stage (red), the formation of H* for a hollow site realizes the lowest potential barrier compared to other adsorption sites having an adsorption energy raining from −1.11 to −1.57 eV, and promotes the HER rate with only a much lower adsorption energy of −0.734 eV.

On the other hand, in the WO₃ surface (blue), the adsorption energy has a higher value (−2.58 to −2.97 eV) than that of the 1T-WS₂ surface, which may be very advantageous for the initial proton adsorption.

This relative energy difference initially promotes the strong binding of H* at the adsorption site of WO₃ and causes the protons to be continuously transferred to the electrochemically active 1T-WS₂ surface, which may prove the supply of protons from WO₃ to 1T-WS₂.

In this case, the Gibbs free energy diagram may be configured to visualize the HER activities in the 1T-WS₂ and WO₃ stages.

Further, as shown in FIG. 6B, 1T-WS₂ has a lower |ΔH*|, which means that hydrogen evolution occurs predominantly on the 1T-WS₂ surface, thereby significantly decreasing the HER overpotential.

Besides, the promotion of the initial proton adsorption is also responsible for the enhanced HER process, and a-WO₃, which is hydrophilic and adsorbs protons, may play an overall important role in transferring the protons to 1T-WS₂ to improve the HER performance.

A schematic diagram of the HER mechanism of proposed WSO catalysts is shown in FIG. 6C.

In this case, the described transfer of protons during the HER can be represented in the following Reaction Formulae 1 to 4.

WS₂+H₃O⁺+e⁻→H_{ad}—WS₂+H₂O [Reaction Formula 1]: Volmer reaction

H_{ad}—WS₂+H₃O⁺+e⁻→WS₂+H₂+H₂O [Reaction Formula 2]: Heyrovsky reaction

xH⁺+xe⁻+WO₃↔HₓWO₃ [Reaction Formula 3]: Proton adsorption/desorption

HₓWO₃—H_{ad}—WS₂ [Reaction Formula 4]: Hydrogen spillover

In general, the electrocatalyst reaction of the HER on the 1T-WS₂ surface in an acidic medium occurs based on the Reaction Formulae 1 to 2.

However, when the a-WO₃ interface is introduced into 1T WS₂, a reaction path may be bypassed because protons are preferentially adsorbed or inserted in a-WO₃ rather than 1T-WS₂.

Therefore, due to a relative binding energy difference between a-WOs and 1T-WS₂, the protons may be initially bonded to a-WO₃ (Reaction Formula 3), and the inserted protons may be transferred to 1T-WS₂ along with the interface (Reaction Formula 4).

Therefore, the sequential HER processes may be performed in order of Reaction Formulae 3-4-2.

In this Case, the Electrocatalytic Activity of WSO is Significantly Increased Even Though the HER-Inactive a-WO₃ Interface is Introduced, and it is Thus Estimated that the 1T-WS₂ Active Site is Lost Due to Partial Oxidation.
This is Closely Related to the Bypassed HER Path Involving the Hydrogen Spillover Effect (HSE), and the Introduced a-WO₃ Interface Provides an Abundant Proton Source to Increase the Activity of WSO.

### Experiment Example 6: An EDS Mapping Analysis of the WS₂/WO₃ Metal Catalysts (WSO)

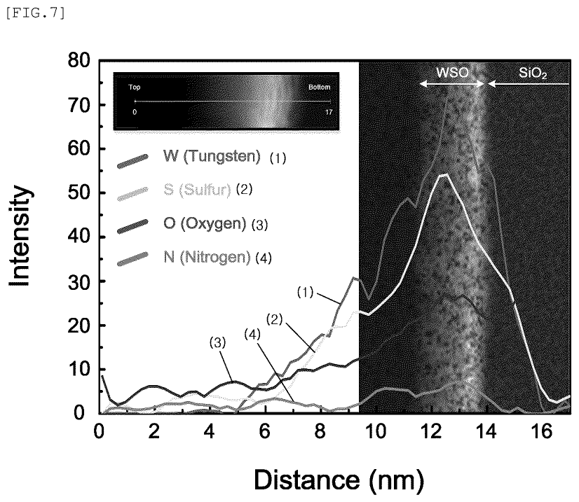

FIG. 7 shows a result of examining ion penetration distances and distribution uniformity after oxygen plasma treatment based on a cross-section energy dispersive spectroscopy (EDS) analysis of metal catalysts according to an embodiment of the disclosure.

Referring to FIG. 7, the ion penetration distances after the oxygen plasma treatment were 1 nm to 5 nm, and it was confirmed through the cross-section EDS that W, S and O were uniformly distributed throughout the thin film. This indicates that the introduction of the oxide interface is not limited to the upper surface of the transition metal sulfide, but forms a uniform interface by smoothly penetrating the transition metal sulfide, when the transition metal oxide is introduced using the oxygen plasma treatment according to the disclosure.

In this case, it was confirmed through the cross-section EDS analysis of FIG. 7 that W, S and O were uniformly distributed throughout the thin film. This means that the oxygen plasma treatment causes the interface to be internally formed by penetration rather than the surface oxidation reaction.

### Experiment Example 7: A Surface Roughness Analysis of the WS₂/WO₃ Metal Catalysts (WSO)

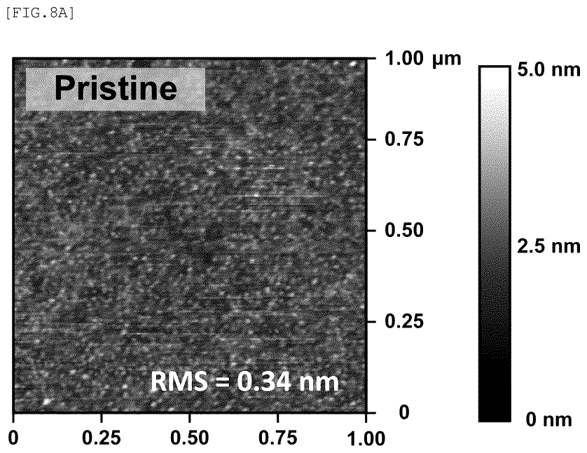

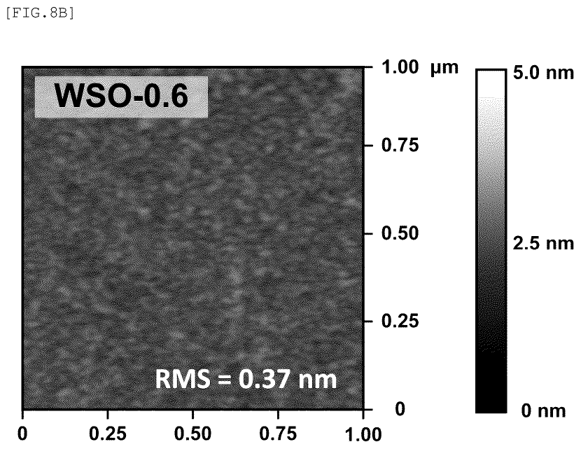

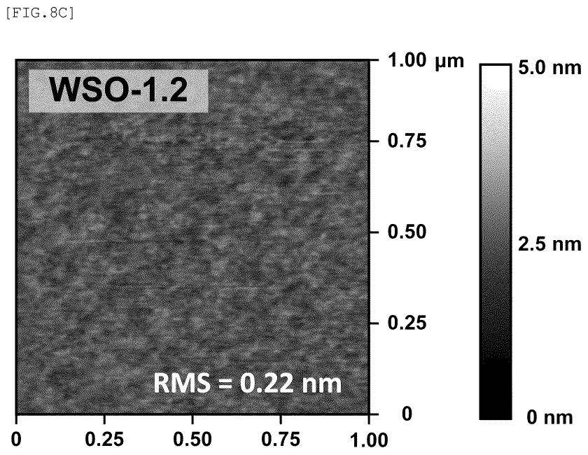

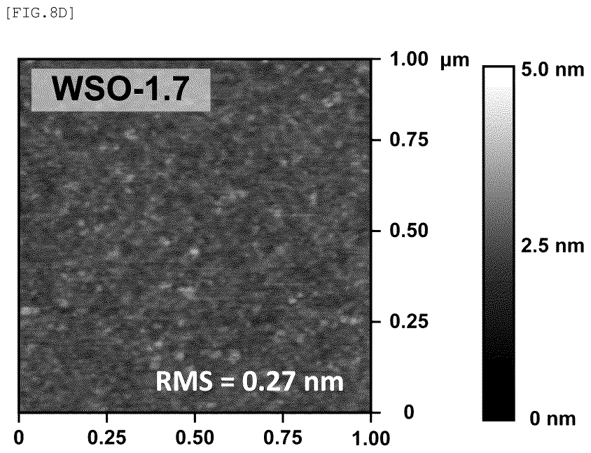

FIGS. 8A to 8D show results of a surface roughness change analysis after oxygen plasma penetration treatment of metal catalysts according to an embodiment of the disclosure.

Referring to FIGS. 8A to 8D, the surface roughness after the oxygen plasma treatment is not significantly changed.

### Experiment Example 8: A Surface SEM Analysis Result of the WS₂/WO₃ Metal Catalysts (WSO)

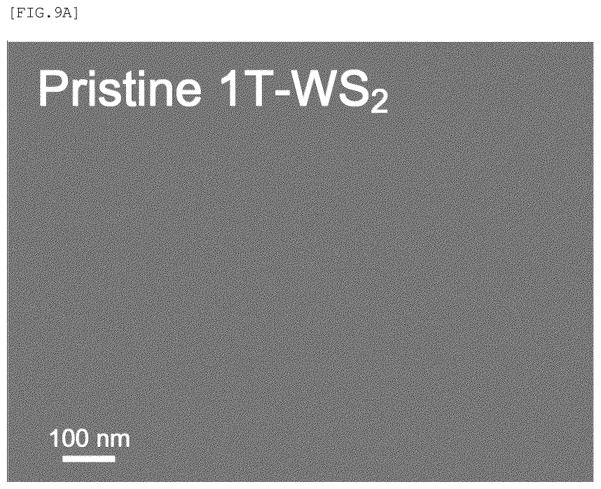

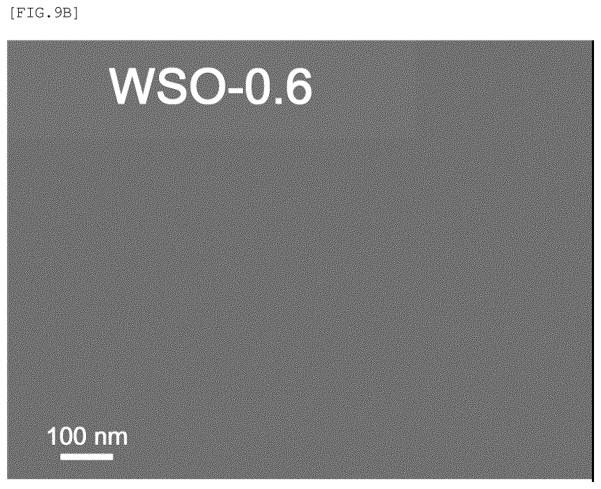

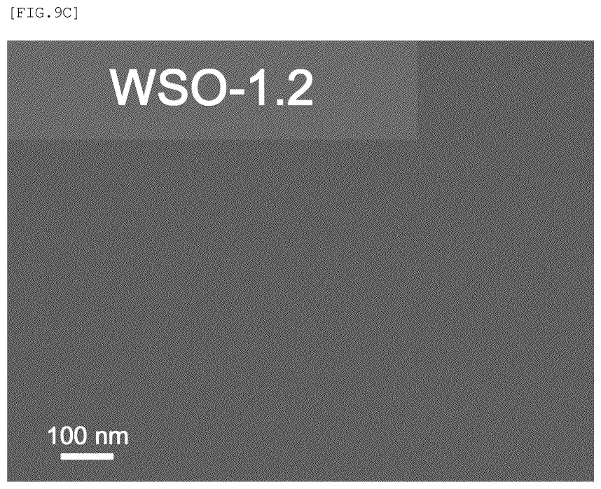

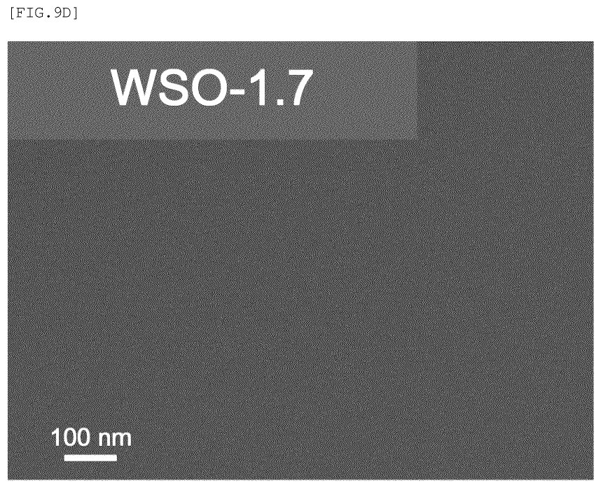

FIGS. 9A to 9D show results of a surface SEM analysis after oxygen plasma penetration treatment according to an embodiment of the disclosure.

Referring to FIGS. 9A to 9D, as a result of analyzing the surface SEM after the oxygen plasma treatment, defects are not formed on the surface by the plasma treatment.

### Experiment Example 9: An Oxygen XPS Analysis Result of the WS₂/WOs Metal Catalysts (WSO)

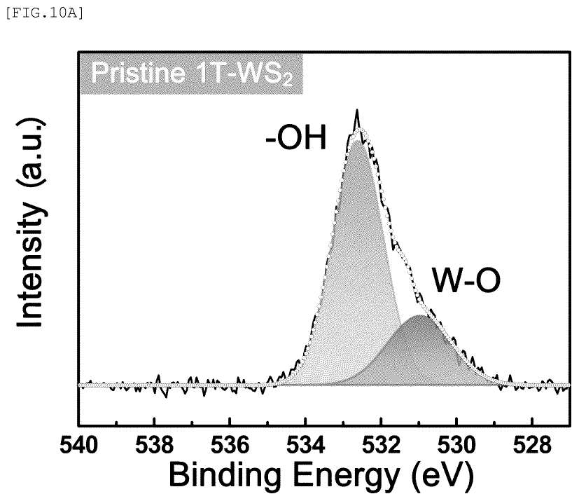

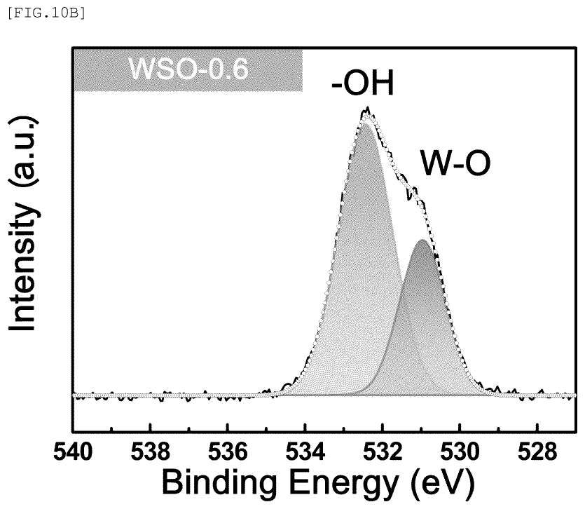

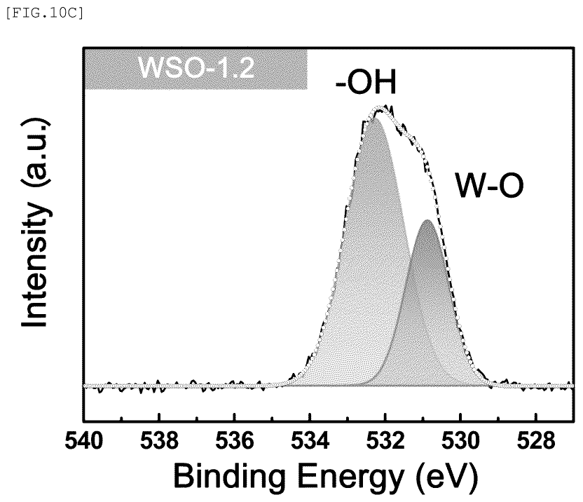

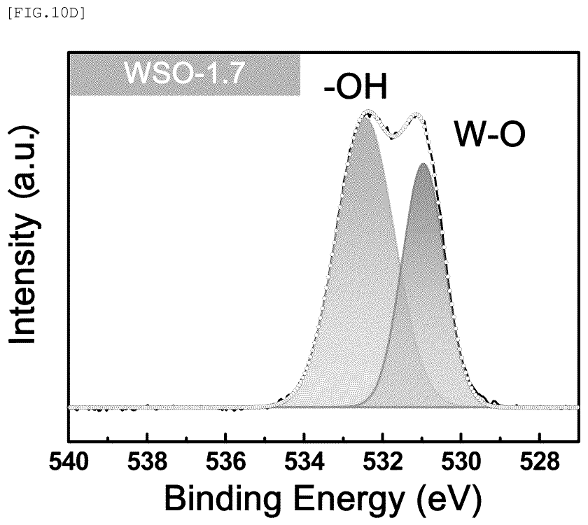

FIGS. 10A to 10D show results of an oxygen XPS analysis after oxygen plasma penetration treatment according to an embodiment of the disclosure.

Referring to FIGS. 10A to 10D, the oxygen XPS analysis results after the oxygen plasma treatment show that the bond between tungsten atoms and oxygen atoms is gradually increased. In general, the XPS analysis results show that the binding energy increases as the oxidation number of the transition metal increases. This may be proved by that the stronger peaks appear in the stronger binding energy region because the oxidation number of tungsten in a WO₃ (W⁶⁺) compound is higher than that in a WS₂ (W⁴⁺) compound.

### Experiment Example 10: A Sulfur XPS Analysis Result of the WS₂/WO₃ Metal Catalysts (WSO)

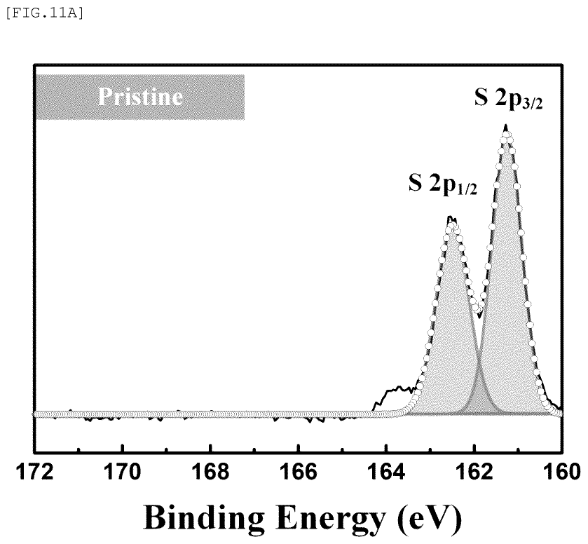

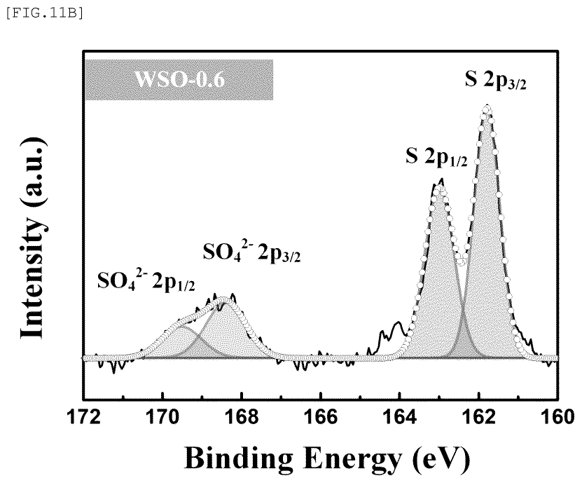

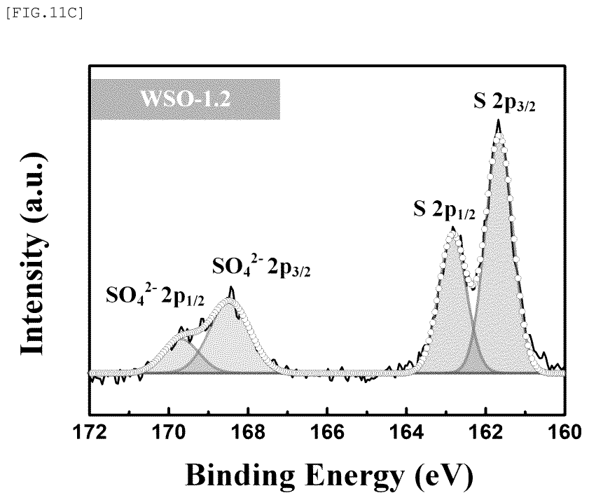

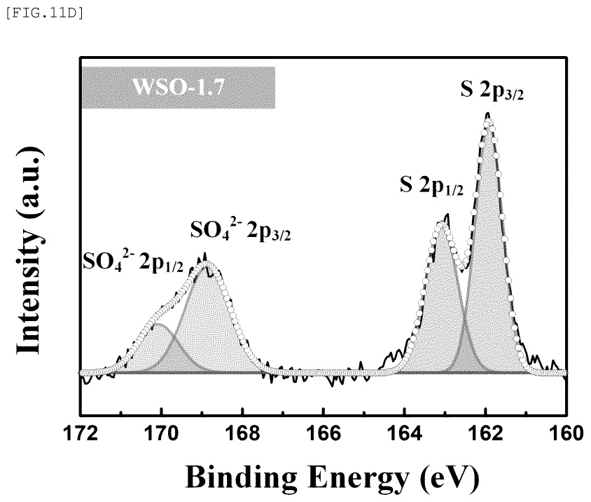

FIGS. 11A to 11D show results of a sulfur XPS analysis after oxygen plasma penetration treatment according to an embodiment of the disclosure.

Referring to FIGS. 11A to 11D, the sulfur XPS analysis results after the oxygen plasma treatment show that the bond between sulfur atoms and oxygen atoms is gradually increased as the plasma treatment time becomes longer.

### Experiment Example 11: Change in the Hydrophilicity/Hydrophobicity of the WS₂/WOs Metal Catalysts (WSO)

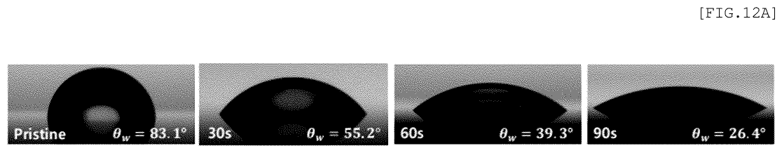

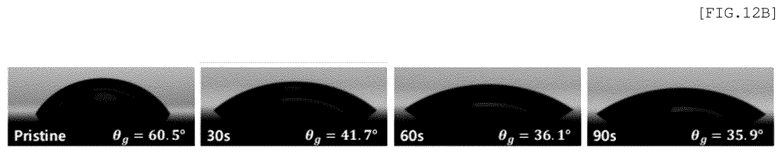

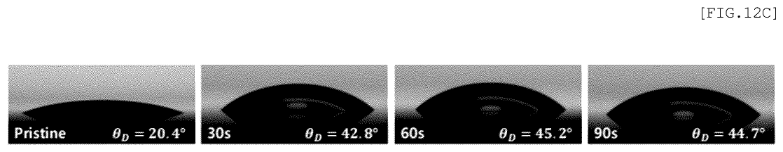

FIG. 12A to FIG. 12C show results of surface change in the hydrophilicity/hydrophobicity depending on treatment time after oxygen plasma penetration treatment according to an embodiment of the disclosure.

Referring to FIGS. 12A to 12C, as results of dropping distilled water, glycerol, and diiodomethane on the WS₂/WO₃ metal catalyst (WSO), the surface characteristics of WSO are changed to have polarity and have higher hydrophilicity as the oxygen plasma treatment time becomes longer.

### Experiment Example 12: Surface Polarity and Dispersion Analysis Data of the WS₂/WO₃ Metal Catalysts (WSO)

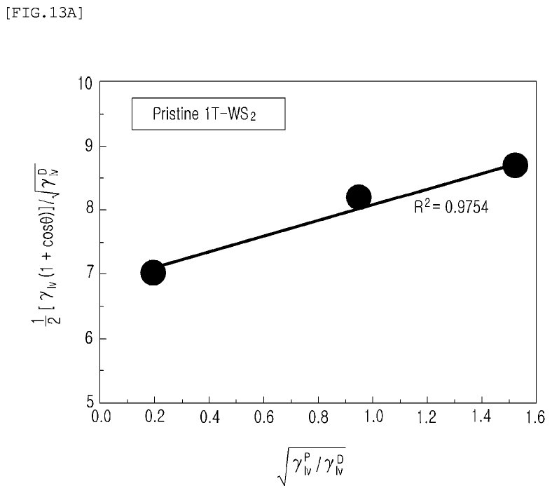

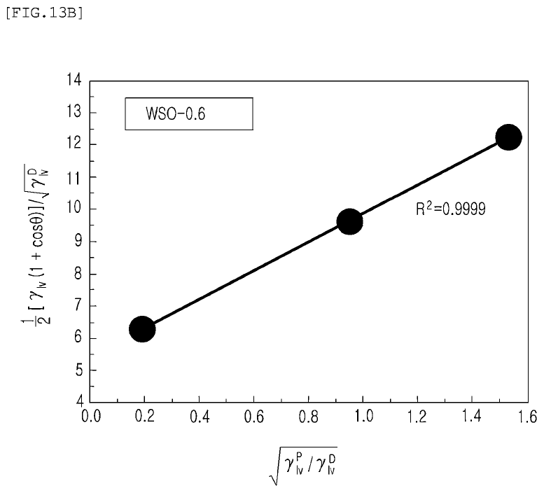

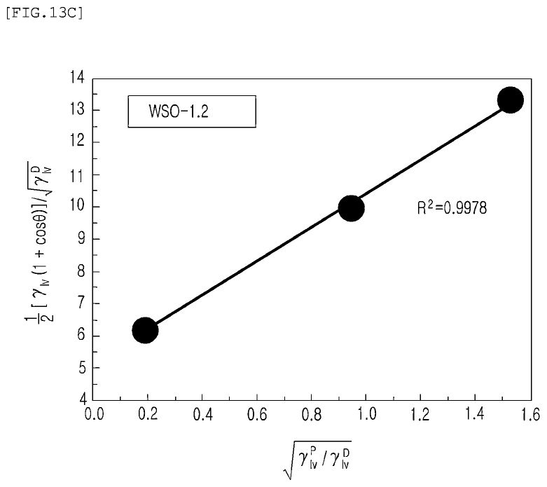

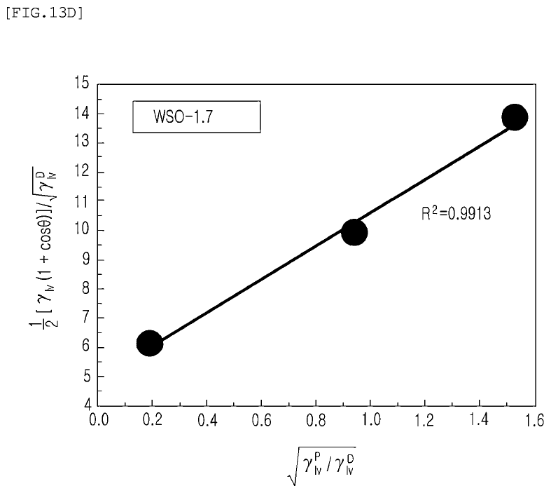

FIGS. 13A to 13D show surface polarity and dispersion analysis data depending on treatment time after oxygen plasma penetration treatment according to an embodiment of the disclosure.

Referring to FIGS. 13A to 13D, the results of analyzing the surface polarity and dispersion depending on the treatment time after the oxygen plasma treatment show that pristine WS₂ has the largest nonpolar surface energy but is gradually increased in polar surface energy and gradually decreased in nonpolar surface energy as treated by oxygen plasma.

The metal catalyst with the vertical heterojunction interface according to an embodiment of the disclosure allows hydrogen adsorbed on the transition metal oxide to be transferred to the transition metal sulfide (hydrogen spillover phenomenon), thereby having effects on having both excellent hydrogen adsorption performance and excellent catalyst activities.

Further, the method of producing the metal catalyst with the vertical heterojunction interface employs an ion penetration reaction based on low-temperature plasma treatment technology, thereby having effects on controlling the heterojunction interface between the transition metal sulfide and the transition metal sulfide at a nanometer level and forming the interface uniformly.

Thus, the hydrogen spillover phenomenon, which occurred locally only at the interface due to a conventional limitation of forming a completely separated heterojunction interface, is expandable to the entire catalyst system.

The effects of the disclosure are not limited to the forementioned effects, but should be understood to include all other effects inferable from the configuration of the disclosure described in the detailed description or claims.

The foregoing descriptions of the disclosure are for illustrative purposes only, and it will be appreciated by a person having ordinary knowledge in the art, to which the disclosure pertains, that change to other specific forms can be made easily without departing from the technical spirit or essential features of the disclosure. Therefore, the foregoing embodiments should be understood as illustrative and not restrictive in all aspects. For example, each component described in a united form may be implemented as divided, and similarly, the components described in a divisional form may also implemented as united.

The scope of the disclosure is defined by the appended claims, and all changes or modifications in the meaning and the scope of the appended claims and their equivalents should be construed as falling within the scope of the disclosure.

What is claimed is:

1. A metal catalyst comprising:
a nano-crystallized transition metal sulfide matrix having a layered structure; and
an amorphous transition metal oxide located in a space between crystals of the transition metal sulfide matrix, and heterogeneously bonded to the transition metal sulfide matrix.

2. The metal catalyst of claim 1, wherein the amorphous transition metal oxide and the transition metal sulfide matrix are heterogeneously bonded so that the transition metal sulfide matrix and the amorphous transition metal oxide can comprise a vertical interface therebetween as the amorphous transition metal oxide is vertically formed in the space of the transition metal sulfide matrix.

3. The metal catalyst of claim 1, wherein hydrogen adsorbed on the amorphous transition metal oxide is transferred to the transition metal sulfide matrix.

4. The metal catalyst of claim 1, wherein a mixing stoichiometric ratio of the transition metal sulfide matrix and the transition metal oxide ranges from 1:0.6 to 1:1.7.

5. The metal catalyst of claim 1, wherein the amorphous transition metal oxide is heterogeneously bonded in the space between the crystals of the transition metal sulfide matrix by ion penetration.

6. The metal catalyst of claim 2, wherein the interface where the transition metal sulfide matrix and the amorphous transition metal oxide are heterogeneously bonded has a length of 10 nm to 20 nm.

7. The metal catalyst of claim 1, wherein the transition metal sulfide matrix comprises one or more selected from a group consisting of WS₂, MoS₂, VS₂, TiS₂, ReS₂, NiS₂, CoS₂ and TaS₂.

8. The metal catalyst of claim 1, wherein the amorphous transition metal oxide comprises one or more selected from a group consisting of WO₃, MOO₃, V₂O₅, TiO₂, ReO₂, NiO₂, CO₃O₄ and TiO₂.

9. A method of producing a metal catalyst, comprising:
preparing a nano-crystallized transition metal sulfide matrix on a wafer; and
preparing a metal catalyst with the amorphous transition metal oxide heterogeneously bonded between crystals of the nano-crystallized transition metal sulfide matrix by treating the nano-crystallized transition metal sulfide matrix with oxygen plasma at a preset temperature for a preset period of time under an atmosphere of oxygen gas and inert gas.

10. The method of claim 9, wherein the preparation of the nano-crystallized transition metal sulfide matrix on the wafer comprises:
depositing a transition metal thin film having a nanometer thickness on the wafer;
preparing a wafer, on which a surface-treated transition metal thin film is deposited, by injecting the wafer formed with the transition metal thin film into a plasma chemical vapor deposition device and then removing a natural oxide film from the transition metal thin film formed on the wafer through hydrogen plasma treatment; and
preparing a nano-crystallized transition metal sulfide matrix by heating the wafer, on which the surface-treated transition metal thin film is deposited, to a preset temperature under an inert gas atmosphere and then adding inert gas and hydrogen sulfide gas and performing plasma treatment to cause a sulfidation reaction by ion penetration on the surface-treated transition metal thin film.

11. The method of claim 9, wherein the amorphous transition metal oxide and the transition metal sulfide matrix are heterogeneously bonded having a vertical interface as the amorphous transition metal oxide is formed vertically penetrating the transition metal sulfide matrix.

12. The method of claim 10 wherein, in the deposition of the transition metal thin film having the nanometer thickness on the wafer, the thickness of the transition metal thin film ranges from 1 nm to 2 nm.

13. The method of claim 9, wherein, in the preparation of the nano-crystallized transition metal sulfide matrix, the preset temperature ranges from 100° C. to 150° C.

14. The method of claim 9, wherein, in the preparation of the metal catalyst with the heterogeneously bonded amorphous transition metal oxide, the oxygen plasma treatment is performed for 30 seconds to 90 seconds.
